(19) United States
(12) Patent Application Publication
(10) Pub. No.: US 2026/0359092 A1
(43) Pub. Date: Nov. 12, 2026

(54) APPARATUS, METHOD, AND STORAGE MEDIUM FOR INTEGRATED IMAGE MANAGEMENT FOR VIRTUAL MACHINES AND CONTAINERS IN CLOUD COMPUTING ENVIRONMENT

(71) Applicant: Electronics and Telecommunications Research Institute, Daejeon (KR)

(72) Inventors: Dae-Won KIM, Daejeon (KR); Jae-Geun CHA, Daejeon (KR); Sun-Wook KIM, Daejeon (KR); Hyun-Hwa CHOI, Daejeon (KR)

(73) Assignee: Electronics and Telecommunications Research Institute, Daejeon (KR)

(21) Appl. No.: 19/671,597

(22) Filed: May 8, 2026

(30) Foreign Application Priority Data
May 9, 2025 (KR) 10-2025-0060200
Apr. 10, 2026 (KR) 10-2026-0065036

(51) Int. Cl. G06F 9/455

(52) U.S. Cl. CPC G06F 9/45558; G06F 2009/4557; G06F 2009/45587; G06F 2009/45595

(57) ABSTRACT

Disclosed herein are an apparatus and method for integrated image management for virtual machines and containers in a cloud-computing environment and a storage medium storing a program for performing the method. The apparatus builds a virtual machine image and a container image based on a common template, performs an image optimization on the built virtual machine image and container image performs a security vulnerability scan on the built virtual machine image and container image, stores the virtual machine image or the container image on which the security vulnerability scan is performed in an image repository, and deploys the virtual machine image or the container image stored in the image repository to a cloud system.

### CROSS REFERENCE TO RELATED APPLICATIONS

This application claims the benefit of Korean Patent Applications No. 10-2025-0060200, filed May 9, 2025, and No. 10-2026-0065036, filed Apr. 10, 2026, which are hereby incorporated by reference in their entireties into this application.

### BACKGROUND OF THE INVENTION

### 1. Technical Field

The present disclosure relates generally to distributed cloud technology, and more particularly to technology for integrated image continuous integration and continuous deployment (CI/CD) for virtual machines and containers in a cloud-computing environment.

### 2. Description of the Related Art

In current distributed edge cloud and cloud-computing environments, containerized platforms have become main platforms for managing the lifecycle of applications. Also, when a container environment is managed and operated as a cluster, not a single node but multiple nodes are operated and managed. In this case, containers are designed to be operated and managed in an integrated manner by utilizing a common container interface.

However, cloud-computing environments have provided virtual machine environments for a long time. Containers are technology for sharing a kernel of a host, and may be simultaneously used on bare metal or virtual machines having a kernel. Therefore, the virtual machines are implemented in various ways using the containers.

In recent cloud and edge-computing environments, virtual machine (VM) and container environments are increasingly used in combination for application execution. Technology related to an integrated resource management system for such environments has been previously proposed.

However, a DevOps environment requires an automated system capable of automatically building, testing, and deploying VM and container images each time code changes are made. Most existing systems are confined to container-centric continuous integration/continuous deployment (CI/CD) or manually build VM images. This may lead to reduced image consistency, deployment delays, and security vulnerabilities.

Meanwhile, U.S. Patent No. 8,826,068, titled “Automated testing of applications in cloud computer systems”, discloses a system and method for performing automated testing of applications in a cloud environment.

### SUMMARY OF THE INVENTION

An object of the present disclosure is to provide an integrated CI/CD-based image generation and deployment structure in virtual machine and container environments.

Another object of the present disclosure is to enable continuous integration and continuous deployment without manual intervention by automatically generating and deploying virtual machine images and container images.

A further object of the present disclosure is to automatically perform image building, testing, and deployment in conjunction with a CI/CD pipeline when code changes.

Yet another object of the present disclosure is to ensure build efficiency through caching and version management of images.

Still another object of the present disclosure is to ensure stability and reliability through security verification and conditional deployment of images.

Still another object of the present disclosure is to maintain a consistent deployment process even in heterogeneous virtualization environments (KVM, Kubernetes, etc.).

Still another object of the present disclosure is to automatically analyze security vulnerabilities and determine deployment according to preset policies, thereby preventing unsafe code from being introduced into an operating environment.

Still another object of the present disclosure is to minimize the likelihood of failures caused by version differences or configuration inconsistencies between generated images.

Still another object of the present disclosure is to efficiently utilize storage space by removing unnecessary layers in an image generation process and managing common images based on a cache.

Still another object of the present disclosure is to reduce the burden associated with high-performance storage or large-capacity storage.

Still another object of the present disclosure is to enable application to various real-world environments, such as distributed cloud, 5G MEC, and edge AI.

In order to accomplish the above objects, an apparatus for integrated image management for virtual machines and containers in a cloud-computing environment according to an embodiment of the present disclosure includes one or more processors and memory for storing at least one program executed by the one or more processors, and the at least one program builds a virtual machine image and a container image based on a common template, performs an image optimization on the built virtual machine image and container image, performs a security vulnerability scan on the built virtual machine image and container image, stores the virtual machine image or the container image on which the security vulnerability scan is performed in an image repository, and deploys the virtual machine image or the container image stored in the image repository to a cloud system.

Here, the image optimization may comprise optimizing storage capacity by removing redundant components from layers common to the built virtual machine image and the built container image and applying caching.

Here, an execution platform may include an integrated runtime environment in which a hypervisor and a container runtime engine are jointly configured within a single node, and the at least one program may control the deployed virtual machine image and container image to be executed concurrently within the single node by sharing scheduling, networking, and storage interfaces.

Here, the at least one program may perform conversion between the built virtual machine image and the built container image to support execution of applications across a virtual machine and a container.

Here, the at least one program may dynamically determine the execution platform to which the image is to be deployed based on performance metrics including resource change events of a cluster and node performance indicators, and may partition a predetermined high-performance device included in the execution platform and allocate a portion thereof according to workload requirements of the image to be deployed.

Also, in order to accomplish the above objects, a method for integrated image management for virtual machines and containers in a cloud-computing environment according to an embodiment of the present disclosure includes building a virtual machine image and a container image based on a common template, performing an image optimization on the built virtual machine image and container image, performing a security vulnerability scan on the built virtual machine image and container image, storing the virtual machine image or the container image on which the security vulnerability scan is performed in an image repository, and deploying the virtual machine image or the container image stored in the image repository to a cloud system.

Here, the image optimization may comprise optimizing storage capacity by removing redundant components from layers common to the built virtual machine image and the built container image and applying caching.

Here, an execution platform may include an integrated runtime environment in which a hypervisor and a container runtime engine are jointly configured within a single node, and deploying the virtual machine image or the container image may comprise controlling the deployed virtual machine image and container image to be executed concurrently within the single node by sharing scheduling, networking, and storage interfaces.

Here, building the virtual machine image and the container image may comprise performing conversion between the built virtual machine image and the built container image to support execution of applications across a virtual machine and a container.

Here, deploying the virtual machine image or the container image may comprise dynamically determining the execution platform to which the image is to be deployed based on performance metrics including resource change events of a cluster and node performance indicators; and partitioning a predetermined high-performance device included in the execution platform and allocating a portion thereof according to workload requirements of the image to be deployed.

In order to accomplish the above objects, a storage medium storing a program for performing a method for integrated image management for virtual machines and containers in a cloud-computing environment according to an embodiment of the present disclosure is provided, and the method includes building a virtual machine image and a container image based on a common template, performing an image optimization on the built virtual machine image and container image, performing a security vulnerability scan on the built virtual machine image and container image, storing the virtual machine image or the container image on which the security vulnerability scan is performed in an image repository, and deploying the virtual machine image or the container image stored in the image repository to a cloud system.

Here, the image optimization may comprise optimizing storage capacity by removing redundant components from layers common to the built virtual machine image and the built container image and applying caching.

Here, an execution platform may include an integrated runtime environment in which a hypervisor and a container runtime engine are jointly configured within a single node, and deploying the virtual machine image or the container image may comprise controlling the deployed virtual machine image and container image to be executed concurrently within the single node by sharing scheduling, networking, and storage interfaces.

Here, building the virtual machine image and the container image may comprise performing conversion between the built virtual machine image and the built container image to support execution of applications across a virtual machine and a container.

Here, deploying the virtual machine image or the container image may comprise dynamically determining the execution platform to which the image is to be deployed based on performance metrics including resource change events of a cluster and node performance indicators; and partitioning a predetermined high-performance device included in the execution platform and allocating a portion thereof according to workload requirements of the image to be deployed.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 a view illustrating a container-based virtualization model according to an embodiment of the present disclosure;

FIG. 2 is a view illustrating a host-based virtualization model according to an embodiment of the present disclosure;

FIG. 3 is a view illustrating a hybrid virtualization model according to an embodiment of the present disclosure;

FIG. 4 is a block diagram illustrating an integrated management structure for virtual machines and containers within a single node in an apparatus for integrated image management for virtual machines and containers in a cloud-computing environment according to an embodiment of the present disclosure;

FIG. 5 is a view illustrating an integrated management structure for virtual machines and containers based on a single cluster in a distributed cloud system according to an embodiment of the present disclosure;

FIG. 6 is a view illustrating the structure of an in-memory container storage engine according to an embodiment of the present disclosure;

FIG. 7 is a view illustrating an example of an image sharing environment of in-memory container storage according to the present disclosure;

FIG. 8 is a view illustrating a process of sharing data in a node having in-memory container storage for providing shared data according to an embodiment of the present disclosure;

FIG. 9 is a view illustrating an example of the detailed structure of the in-memory container storage management module illustrated in FIG. 7;

FIG. 10 is a flowchart illustrating a process of managing data sharing in an in-memory container storage management module according to an embodiment of the present disclosure;

FIG. 11 is a view illustrating an integrated management structure for virtual machines and containers based on multiple clusters in a distributed cloud system according to an embodiment of the present disclosure;

FIG. 12 is a flowchart illustrating a method for integrated image management for virtual machines and containers in a cloud-computing environment according to an embodiment of the present disclosure;

FIG. 13 is a block diagram illustrating an integrated management structure for virtual machines and containers based on multiple clusters in an apparatus for integrated image management for virtual machines and containers in a cloud-computing environment according to an embodiment of the present disclosure;

FIG. 14 is a view illustrating network connection types of heterogeneous virtual environments based on an edge-computing configuration according to an embodiment of the present disclosure;

FIG. 15 is a view illustrating a network connection structure for heterogeneous virtual environments in a single node according to an embodiment of the present disclosure;

FIG. 16 is a block diagram illustrating function blocks of a worker node according to an embodiment of the present disclosure;

FIG. 17 is a view illustrating a network connection configuration for heterogeneous virtual environments between multiple clusters according to an embodiment of the present disclosure;

FIG. 18 is a flowchart illustrating a method for managing a multi-cluster service network based on heterogeneous virtual environments according to an embodiment of the present disclosure;

FIG. 19 is a view illustrating a multi-cluster manager according to an embodiment of the present disclosure;

FIG. 20 is a block diagram illustrating an apparatus for integrated image management for virtual machines and containers in a cloud-computing environment according to an embodiment of the present disclosure;

FIG. 21 is a flowchart illustrating a method for integrated image management for virtual machines and containers in a cloud-computing environment according to an embodiment of the present disclosure; and

FIG. 22 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

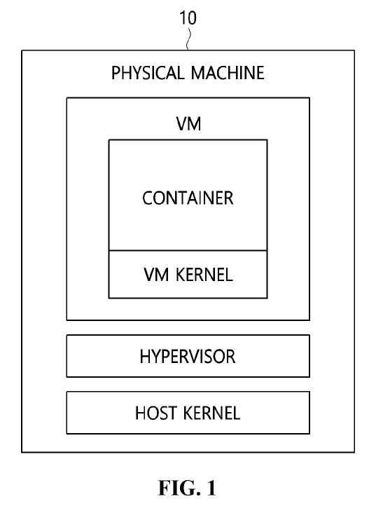

FIG. 1 is a view illustrating a container-based virtualization model according to an embodiment of the present disclosure.

Referring to FIG. 1, the container-based virtualization model 10 may be used to execute an application in a virtual machine of a physical machine. The container-based virtualization model 10 may be useful for applications that require a specific operating system (OS) or hardware environment independent of the OS of the physical system.

The container-based virtualization model 10 may be a common approach for using containers and virtual machines together. In the container-based virtualization model 10, a container may be executed in a separate virtual machine or executed through multiple virtual machines. The container-based virtualization models 10 may provide a high level of isolation and security for each container.

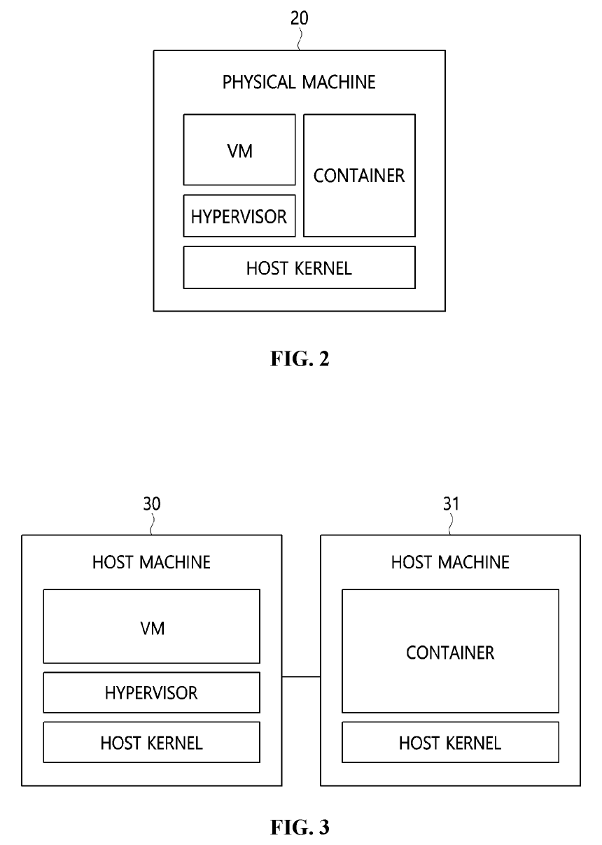

FIG. 2 is a view illustrating a host-based virtualization model according to an embodiment of the present disclosure.

Referring to FIG. 2, the host-based virtualization model 20 allows a container to be directly executed on a host operating system (OS) kernel and allows a virtual machine to be executed through a hypervisor on the same kernel. The host-based virtualization model may be useful for applications that improve resource efficiency and flexibility in operation management.

The virtual machine uses the hardware of a host machine exclusively, which may reduce resource efficiency. However, the container provides a runtime environment that shares the hardware of the host system and includes only a portion of the host OS, which may improve resource efficiency. Therefore, when the virtual machine and the container are used together, resource efficiency and operation flexibility may be improved.

The host-based virtualization model 20 may be a common model capable of executing the container directly on the host OS. The host-based virtualization model 20 may provide significant performance improvement to containerized applications. Also, the host-based virtualization model 20 may use the virtual machine when an application requires isolation and security.

FIG. 3 is a view illustrating a hybrid virtualization model according to an embodiment of the present disclosure.

Referring to FIG. 3, the hybrid virtualization model (30, 31) may execute applications in various physical machines using a combination of containers and virtual machines. Therefore, the hybrid virtualization model (30, 31) may be useful for applications that require an infrastructure mixture that includes infrastructures without virtualization or clustering of physical systems in order to operate a distributed cloud system (e.g., a distributed cloud and edge computing).

The hybrid virtualization model (30, 31) is a more flexible model that allows a mixture of infrastructures regardless of whether a container and a virtual machine are present. In the hybrid virtualization model (30, 31), some applications may be executed through containers, whereas other applications may be executed through virtual machines or non-virtualized physical machines. The hybrid virtualization model (30, 31) may be useful for a Cloud Service Provider (CSP) that adopts legacy applications without virtualization.

An integration model for using a container and a virtual machine together may vary depending on specific requirements of the CSP.

A CSP requiring a mixture of containerized infrastructures and non-containerized infrastructures may consider the hybrid virtualization model (30, 31). A CSP requiring a high level of isolation and security may consider the container-based virtualization model 10. Also, a CSP requiring a high level of performance may consider the host-based virtualization model 20.

An apparatus for integrated image management for virtual machines and containers in a cloud-computing environment corresponding to a distributed cloud system according to an embodiment of the present disclosure may perform integrated management of virtual machines and containers based on a single node.

Main components managed by the container for management of the integration model may include a container file system, a container engine, and a container image.

The container file system is a system for storing and managing container images.

The container engine is a system for executing and managing a container using a container image.

The container image is a software package configured to execute an application for a container.

The virtual machine may be executed and managed through a hypervisor. Components managed by the hypervisor may include a virtual machine, a virtual machine image, a host resource interface to be allocated to the virtual machine, and the like.

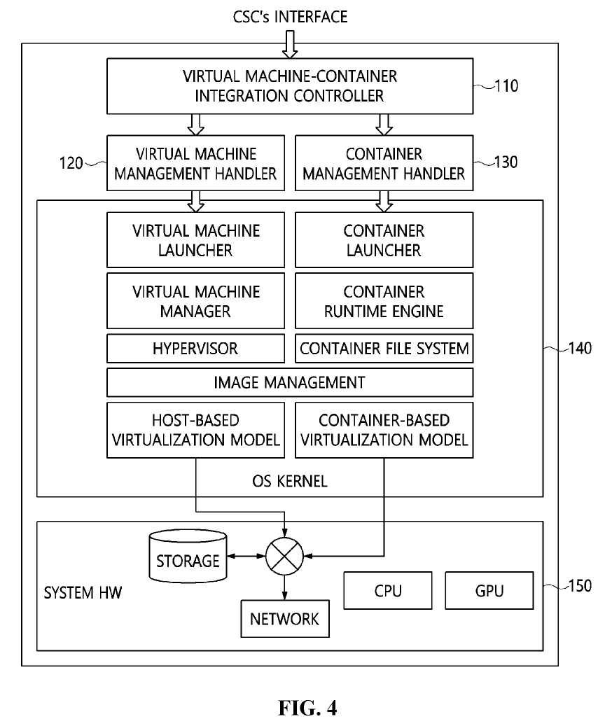

FIG. 4 is a block diagram illustrating an integrated management structure for virtual machines and containers based on a single node in an apparatus for integrated image management for virtual machines and containers in a cloud-computing environment according to an embodiment of the present disclosure.

Referring to FIG. 4, it can be seen that an integrated management structure for virtual machines and containers based on a single node in an apparatus for integrated image management for virtual machines and containers in a cloud-computing environment according to an embodiment of the present disclosure is illustrated.

The apparatus for integrated image management for virtual machines and containers in a cloud-computing environment according to an embodiment of the present disclosure may include a virtual machine-(VM-) container integration controller 110, a virtual machine management handler 120, a container management handler 130, a virtual machine- (VM-) container executor 140, and a storage management unit 150.

Here, the VM-container integration controller 110 may perform integrated management of a single node.

Here, the VM-container integration controller 110 may receive a request (command) from a user (a CSC’s interface).

Here, the computing node that uses a computing resource may receive the user request through the VM-container integration controller 110.

Here, the VM-container integration controller 110 may classify the request (command) of the user depending on whether it corresponds to VM management or container management and may transmit the request to any one of the virtual machine management handler 120 and the container management handler 130.

Here, the VM-container integration controller 110 may classify the received user request depending on the type of the virtualization machine of the computing resource.

Here, the VM-container integration controller 110 may include an API service for handling and storing the request of the user (the CSC’s interface).

Here, the VM-container integration controller 110 may operate at a higher level by focusing on a software agent in the API, as opposed to the handler that directly interacts with a VM.

Here, the VM-container integration controller 110 may continuously compare the desired state of a virtual machine instance (VMI) (defined in the VMI) with the actual state of a hypervisor in order to adjust the desired state and the actual state.

Here, when there is a discrepancy between the desired state and the actual state, the VM-container integration controller 110 may take a necessary measure for adjustment.

Here, the VM-container integration controller 110 may perform a task, such as creating, starting, stopping, updating, or deleting a VM based on a predefined VMI configuration.

Here, the VM-container integration controller 110 may perform the VM task in collaboration with additional components for integrated management of virtual machines and containers, such as the handlers 120 and 130 and the executor 140, rather than independently operating for interaction with the additional components.

Here, in order to start a new VM, the VM-container integration controller 110 may send a guideline for managing the actual VM in the hypervisor to the handlers 120 and 130 while coordinating with a launcher.

Here, the VM-container integration controller 110 may facilitate the connection between a virtual machine instance (VMI) and a Kubernetes pod through pod connection processing. Accordingly, the pod may integrate virtualized workloads smoothly by interacting with a specific VM.

Here, the VM-container integration controller 110 may manage a container-based virtualization machine and a hybrid virtualization machine in an integrated manner.

The container-based virtualization machine may virtualize and provide an application that is containerized by being installed in a first virtualization machine that virtualizes a computing resource.

The hybrid virtualization machine may virtualize and provide an application that is containerized by being installed in a second virtualization machine that virtualizes a computing resource and/or may virtualize and provide an application containerized on the computing resource.

Here, the VM-container integration controller 110 may receive a user request, provide the user request to a first interface of the container-based virtualization machine and a second interface of the hybrid virtualization machine, and perform integrated management of virtualization of the computing node.

Here, the VM-container integration controller 110 may classify the received user request depending on the type of the virtualization machine and provide the user request, which is classified depending on the type of the virtualization machine, to the first interface or the second interface.

Here, the container-based virtualization machine and the hybrid virtualization machine may be installed in an OS kernel in the computing node.

Here, the VM-container integration controller 110 may provide an image management function for the container-based virtualization machine or the hybrid virtualization machine depending on the image management function installed in the OS kernel in the computing node.

Here, the VM-container integration controller 110 may manage the container-based virtualization machine or the hybrid virtualization machine based on a library on an OS in the computing node or through a software daemon in the computing node.

The virtual machine and container management handlers 120 and 130 may receive a request of a CSC from the VM-container integration controller 110 and transmit the same to the virtual machine and container executor 140.

Here, the virtual machine and container management handlers 120 and 130 may receive the initial specifications of a virtual machine and a container and send a signal to start any one of the virtual machine and the container corresponding to each execution program.

Here, the virtual machine and container management handlers 120 and 130 may manage the lifecycle of the virtual machine and container and communication thereof with the host OS, such as network traffic forwarding.

Here, the virtual machine and container management handlers 120 and 130 may represent the virtual machine as a Virtual Machine Instance (VMI).

Here, the virtual machine and container management handlers 120 and 130 may manage Virtual Machine Instances (VMIs) in the integrated management for virtual machines and containers.

Also, the virtual machine and container management handlers 120 and 130 may perform VMI lifecycle management.

Here, when a VMI is created through an API, the virtual machine and container management handlers 120 and 130 may receive a VMI specification and execute the VM by sending a signal to an execution program, which is another component.

Here, the virtual machine and container management handlers 120 and 130 may interact with the underlying hypervisor using a library, configure the VM based on the detailed information of the VMI, and start the VM.

Here, the virtual machine and container management handlers 120 and 130 may continuously monitor the state of the VM that is being executed.

Here, the virtual machine and container management handlers 120 and 130 may receive a signal (e.g., a crash) from the VM and update the VMI state in the API based thereon.

Here, the virtual machine and container management handlers 120 and 130 may safely stop or terminate the VM when there is an instruction.

Also, the virtual machine and container management handlers 120 and 130 may bridge the controller and a VM container.

Here, the virtual machine and container management handlers 120 and 130 may serve as a communication bridge between a cluster and a guest VM.

Accordingly, the virtual machine and container management handlers 120 and 130 may use functions such as real-time migration, console access, network traffic transfer between the VM and the container, and the like.

Here, when the API (e.g., resource allocation) is changed by the desired state of the VMI, the virtual machine and container management handlers 120 and 130 may perform agent update by which the change is converted into adjustment of the VM itself and by which whether the adjustment matches the desired configuration is checked.

Also, the virtual machine and container management handlers 120 and 130 implement their own heartbeat mechanisms, thereby detecting unresponsive nodes in the cluster.

Accordingly, the virtual machine and container management handlers 120 and 130 may identify and solve problems more quickly.

Also, the virtual machine and container management handlers 120 and 130 may design a security function as a single authorized component in the integrated management for virtual machines and containers.

Here, the virtual machine and container management handlers 120 and 130 may handle sensitive tasks such as VM creation and configuration that require root access.

Generally, the virtual machine and container management handlers 120 and 130, which are essential components for the integrated management for virtual machines and containers, manage the lifecycle of the VM, establish communication between the controller 110 and a guest, and perform other critical tasks, thereby ensuring smooth operation of virtualized workloads.

Here, the virtual machine and container management handlers 120 and 130 may handle VM lifecycle management and communication.

The handlers 120 and 130 and the controller 110 may manage the VM lifecycle and interact with an extensive ecosystem for integrated management of virtual machines and containers.

An abstraction level allows the controller 110 to handle an upper-level representation of a VM (VMI) in the API and allows the handlers 120 and 130 to handle lower-level interaction with the actual VM in the hypervisor.

The controller 110 manages the entire lifecycle of a VMI depending on the desired state, whereas the handlers 120 and 130 may perform a specific task, such as starting, stopping, and monitoring a physical VM.

In summary, both the controller 110 and the handlers 120 and 130 are critical components for integrated management for virtual machines and containers, and may take complementary roles in virtual machine management.

The controller 110 may reflect the state desired by the VMI and coordinate with other components, whereas the handlers 120 and 130 may manipulate the actual VM by performing a specific task on the hypervisor.

The VM-container executor 140 may use software installed in the OS kernel.

The VM-container executor 140 may include a virtual machine launcher and a container launcher.

The virtual machine launcher and the container launcher may support various types of interface methods to be executed to start a virtual machine and a container.

The virtual machine launcher and the container launcher may be used as libraries of the host operating system or as software agents.

In order to provide control groups (cgroup) and namespace, the VM-container executor 140 may send a guideline to a controller agent through an API when a virtual machine instance (VMI) is created. According to the guideline, the controller agent may create an instance specifically for the corresponding VMI. Within this instance, the underlying container may execute an execution program.

The VM-container executor 140 may provide cgroup and namespace required for a VM process as the primary role of a launch manager. This may be a primary kernel mechanism for isolating and controlling resources (a CPU, memory, etc.) for individual VMs and network visibility.

The VM-container executor 140 may play a more intensive role in setting the initial environment of a VM.

The VM-container executor 140 may set the initial VM environment (cgroup, namespace, and configuration).

The VM-container executor 140 operates within a VM instance itself, whereas the handlers 120 and 130 may interact directly with the hypervisor and the controller 110 may supervise VMI management at a higher level in the API.

The VM-container executor 140 interacts with libraryt, whereby the execution program may manage VM creation and configuration in the underlying hypervisor (e.g., Kernel-based Virtual Machine (KVM)) through the library. The VM-container executor 140 may define the resource and configuration of a VM using a VMI specification.

The storage management unit 150 may use in-memory-based storage and an in-memory-based container structure in order to use data and storage between a container and a VM.

Among the usage models of a virtual machine and a container, models configured in a single node may include a host-based virtualization model and a container-based virtualization model.

In the case of a hybrid virtualization model, a virtual machine is considered a node and may be connected to another virtual machine having a container.

The storage management unit 150 includes an image manager for storing and managing data for image management for both a container and a virtual machine, and may improve the performance of the container and virtual machine by utilizing various types of high-performance storage (memory, Non-Volatile Memory express (NVMe), a Solid-State Drive (SSD), federation storage, etc.).

The storage management unit 150 may use an in-memory-based container storage system as a repository for configuring a virtual machine image or a container file system (an additional function for image management).

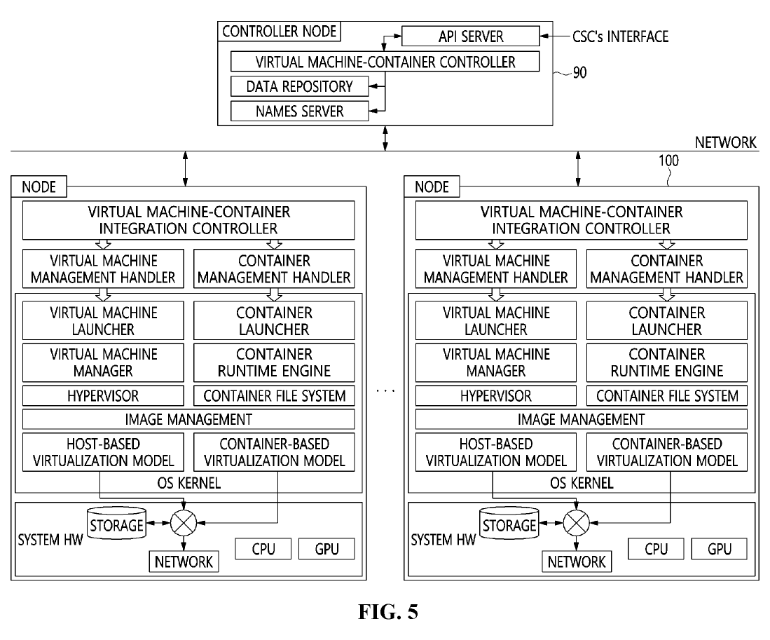

FIG. 5 is a view illustrating an integrated management structure for virtual machines and containers based on a single cluster in a distributed cloud system according to an embodiment of the present disclosure.

Referring to FIG. 5, it can be seen that integrated management of virtual machines and containers in a single cluster is illustrated.

In FIG. 5, a controller node 90 may serve to configure, manage, monitor, and control a cluster. The controller node 90 may share data between nodes and distribute tasks using a data repository.

The data repository may provide distributed repositories for cluster configuration sharing, a service search, and scheduler adjustment.

In a single cluster model, the controller node 90 may include a VM-container integration controller, and each node 100 corresponding to an apparatus for integrated image management for virtual machines and containers in a cloud-computing environment may include a VM-container control agent connected to the VM-container integration controller of the controller node 90.

A request of a CSC may be transferred to the VM-container integration controller of each node 100 through the API server of the controller node 90.

The VM-container integration controller of each node 100 may execute the request of the CSC and send the request of the CSC to virtual machine and container management handlers through the VM-container integration control agent. Each node 100 may have the same structure as the single-node model described in FIG. 4.

The VM-container integration controller of the controller node 90 may manage the entire lifecycle of virtual machines and containers in the cluster in the API server. In addition to the single-node model, the VM-container integration controller may provide scheduling and policy reflection functions.

The VM-container integration control agent is provided as a software program, and a virtual machine management handler or a container management handler may be deployed depending on whether the current system is a container-based system or a virtual-machine-based system.

For example, when the current system is a container-based system, a virtual machine controller may be deployed, whereas when it is a virtual-machine-based system, a container controller for managing each model may be deployed.

The controller is provided in the form of software, and a VM handler or a container handler may be deployed depending on whether the current system is a container-based system or a VM management system. For example, in the case of OpenStack, in which virtual machine management is a core structure, the container handler configures a container-based virtualization model that includes a container structure in a virtual machine, whereby the virtual machine and the container may be used together. In the case of a container-based structure such as Kubernetes (K8s), a handler (Custom Resource Definitions (CRD) operator) for a virtual machine is deployed, whereby it is managed as a hybrid model.

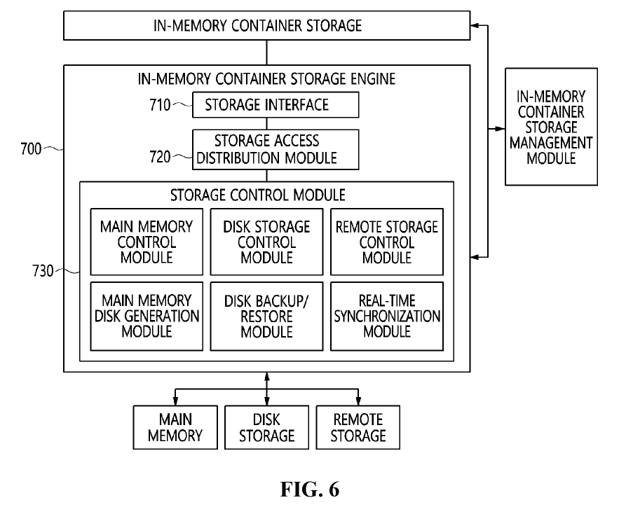

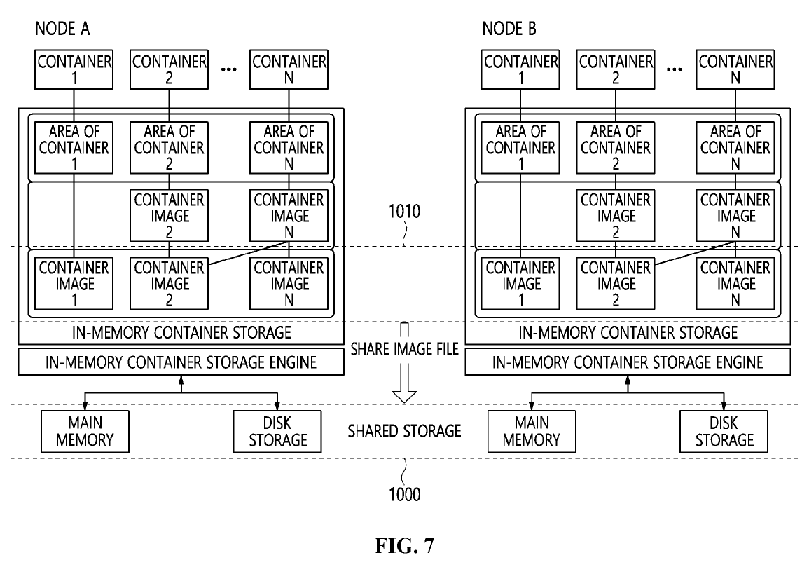

FIG. 6 is a view illustrating the structure of an in-memory container storage engine according to an embodiment of the present disclosure.

Referring to FIG. 6, the in-memory container storage engine 700 may include a storage interface module 710, a storage access distribution module 720, and a storage control module 730.

First, the storage interface module 710 may provide a standard block storage interface and receive a disk access command generated from a container. The received command may be transferred to the storage access distribution module 720.

Depending on the characteristics of the disk access command, the storage access distribution module 720 may determine which of main memory storage, disk storage, or remote storage to use in order to run a service. Subsequently, the access command may be transferred to a main memory control module, a disk storage control module, and a remote storage control module included in the storage control module 730.

The storage control module 730 may include the main memory control module, the disk storage control module, the remote storage control module, a main memory disk generation module, a disk backup/restore module, and a real-time synchronization module.

The main memory control module may process a disk access command using main memory, thereby providing high access speed.

For example, when the main memory control module receives disk access commands, the disk access commands transferred in units of blocks may be processed to perform actual read/write operations on the main memory, which is accessible by address, through the main memory disk generation module. Accordingly, data of a virtual disk may be generated and stored in the main memory.

The disk storage control module may process a virtual desk access command using disk storage.

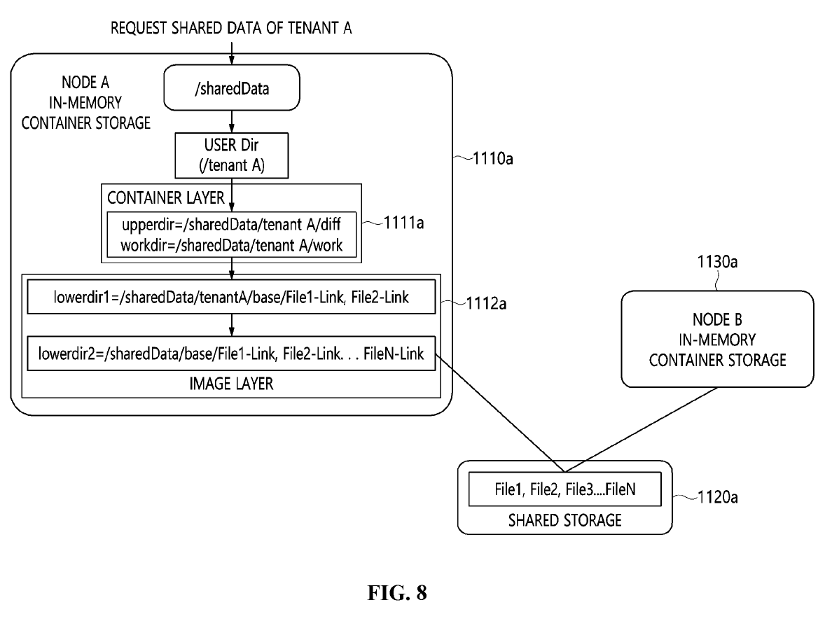

FIG. 7 is a view illustrating an example of an image sharing environment of in-memory container storage according to the present disclosure.

Referring to FIG. 7, shared storage 1000 may be used to provide shared data in in-memory container storage according to the present disclosure.

For example, the shared storage 1000 may be network file storage (a storage area network (SAN), network-attached storage (NAS), etc.) or storage connected to a local disk.

Referring to FIG. 7, the image sharing environment according to the present disclosure may have a structure that provides a user with a container image stored in the shared storage 1000 in response to a request of the user.

For example, a sharing management function may be provided through the container file system layer management module of the in-memory container storage management module illustrated in FIG. 7, and shared data 1010 may be provided to a user by individually configuring the area for file sharing and providing the same to the user.

FIG. 8 is a view illustrating a process of sharing data in a node having in-memory container storage for providing shared data according to an embodiment of the present disclosure.

Hereinafter, a process by which a node having in-memory container storage for providing shared data, as shown in FIG. 7, shares data will be described in detail with reference to FIG. 8.

FIG. 8 illustrates a user (tenant) access method that is able to improve security in such a way that, when data is shared according to the present disclosure, the data desired to be shared is separated and provided depending on the group to use the data, rather than sharing all data.

First, in response to a request from the user (tenant), the directory of the user (/sharedData/tenant) may be created in the in-memory container storage 1110a of node A, and a directory (diff) may be created and mapped under the directory of the user (/sharedData/tenant) in the container layer 1111a (upper directory). Here, deduplicated data may be used as the data of the user for file system management. The created diff directory may correspond to the container layer and correspond to data stored by the user by accessing or editing/modifying a file. Also, a work directory may be created and mapped under the directory of the user. The work directory may correspond to the user data storage area of the container layer.

Also, a lower directory (lowerdir2=/sharedData/base/File1-Link, File2-Link, …, FileN-Link/) located at the lowest position in the image layer 1112a is a management point that stores links to all files in shared storage 1120a, and may be set to (/sharedData/base...).

In the image layer 1112a, the lower directory (lowerdir2=/sharedData/base/File1-Link, File2-Link, …, FileN-Link/) may be exposed to the management system such that the user is able to select a necessary file, and another lower directory (lowerdir1=/sharedData/tenantA/base/File1-Link, File2-Link) created in the image layer 1112a may be associated with the upper directory, whereby only the link information for the file selected by the user may be deployed.

Through this process, the user may view only the files selected by the user through the lower system.

Accordingly, the user may receive the file through the user directory shared with the user, and the lower directories may always remain unchanged. In other words, the lower directories are used as read-only, which may efficiently prevent the problem of writes when multiple people share data. When a change is made to a file in the lower directory, the change is written in the upper directory, whereby all of the shared files may be efficiently managed.

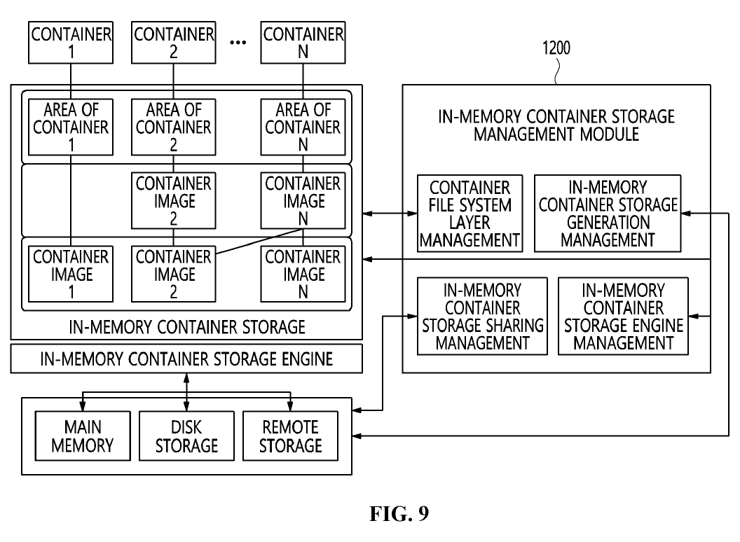

FIG. 9 is a view illustrating an example of the detailed structure of the in-memory container storage management module illustrated in FIG. 7.

Referring to FIG. 9, the in-memory container storage management module 1200 according to the present disclosure may include a container file system layer management module, an in-memory container storage generation management module, an in-memory container storage sharing management module, and an in-memory container storage engine management module.

The container file system layer management module may monitor the current state and running state of a container file system. Also, the container file system layer management module may manage the creation and state of the container system when in-memory container storage is used.

The in-memory container storage generation management module may create in-memory container storage when a container is configured in the form of in-memory in response to a request of a user. Here, when the in-memory container storage has been created, the container file system layer management module creates a container file system of the system.

The in-memory container storage sharing management module may create a shared file system between storage units to share an image layer in response to a request of a user and perform a task of synchronizing the shared file system. Here, link information in the image layer may be merged into a single system and synchronized.

The in-memory container storage engine management module may create and run an in-memory container storage driver of the system and monitor the state thereof.

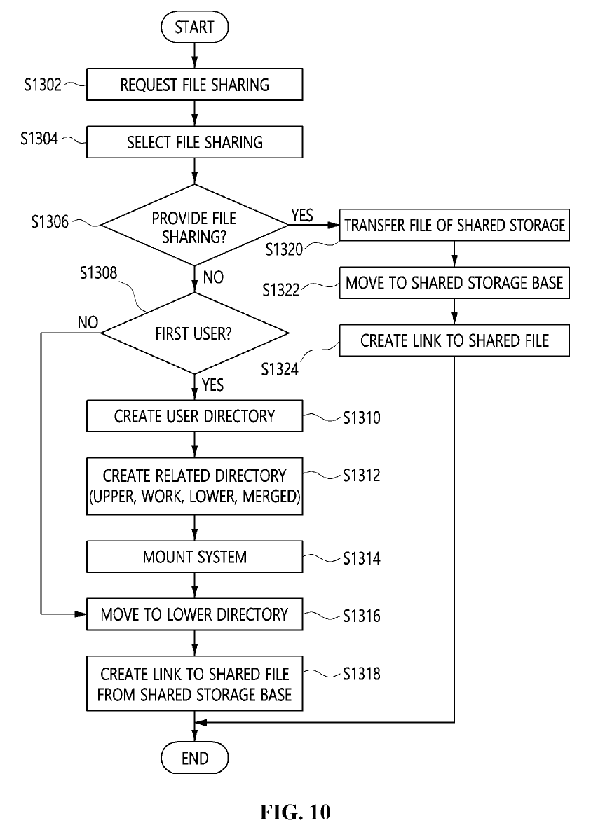

FIG. 10 is a flowchart illustrating a process of managing data sharing in an in-memory container storage management module according to an embodiment of the present disclosure.

Hereinafter, a process by which an in-memory container storage management module according to the present disclosure performs data sharing management will be described in detail with reference to FIG. 10.

First, a user (tenant) may access a system and request and select file sharing at steps S1302 and S1304.

Here, the user may be classified as a user to be provided with file sharing or a provider to provide file sharing.

Accordingly, whether the user is a provider to provide file sharing may be determined at step S1306.

When it is determined at step S1306 that the user is a user to be provided with file sharing, whether the user is the first user may be determined at step S1308.

When it is determined at step S1308 that the user is the first user, a user directory is created at step S1310, relevant directories are created at step S1312, and the entire system environment may be mounted at step S1314.

Subsequently, after moving to the lower directory of the user directory at step S1316, link information for the shared file requested by the user may be created by retrieving the same from a shared storage base at step S1318.

Also, when it is determined at step S1308 that the user is not the first user, link information for the shared file requested by the user may be created by retrieving the same from the shared storage base at step S1318 after directly moving to the lower directory of the user directory at step S1316.

Also, when it is determined at step S1306 that the user is a provider to provide file sharing, a file is uploaded by accessing the shared storage at step S1320, and a link to the shared file may be created at step S1324 after moving to the shared storage base at step S1322.

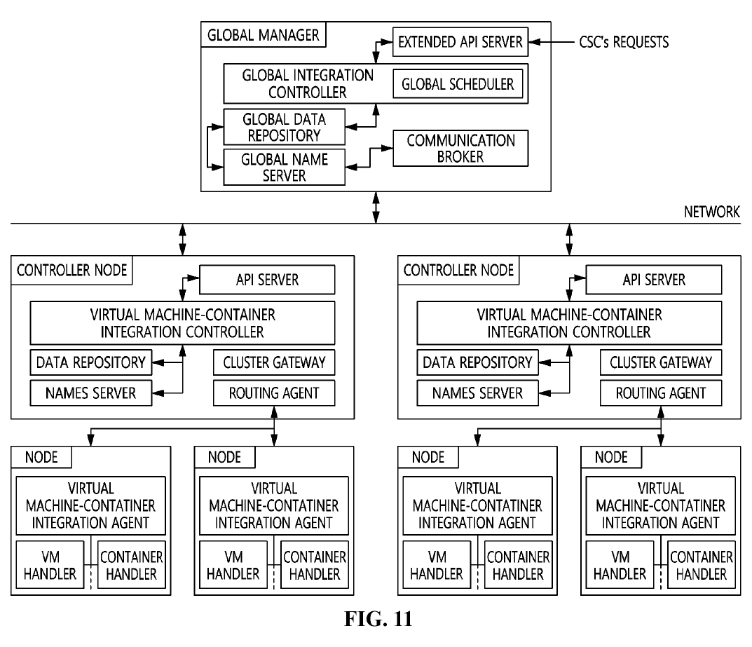

FIG. 11 is a view illustrating an integrated management structure for virtual machines and containers based on multiple clusters in a distributed cloud system according to an embodiment of the present disclosure.

Referring to FIG. 11, a global manager node 80 may provide a function to connect existing clusters for integrated management of virtual machines and containers between the multiple clusters.

The existing cluster may include the controller node 90 and the multiple single-node integrated management apparatuses 100 described in FIG. 5.

To this end, each of the clusters may include a network connectivity function in the existing single-cluster integrated management function.

The global manager node 80 may include an upper-level extended API server, a global data repository, and a global scheduler for the integrated management.

First, the controller node 90 of each of the multiple clusters may provide a high-speed network gateway function for connection over a network and an underlying routing agent function for recognition in the cluster. The gateway and the router are management functions on the cluster. Here, a network broker may be deployed in a global manager, and the gateway and the router may be deployed in each of the clusters through the global scheduler.

The high-speed network gateway is a network connection scheme for connecting and operating the multiple clusters at high speeds, and the connection may be established using tunneling between the two networks of the controller nodes 90.

Tunneling may ensure reliable data transmission by encapsulating a payload in a tunneling section and utilizing a specific protocol. Tunneling may be applied to layers L7, L3, and L2, among the seven layers of the Internet. As the layer of the supported tunneling is lower, a lot of protocols used at upper layers may be used without change, and faster performance may be provided. In this system, two clusters may be connected using L3 tunneling. Also, the protocols used for tunneling often have low processing speeds compared to other protocols. In order to overcome this, the system may establish connection to the tunneling network by utilizing a user-level network driver (Data Plane Development Kit (DPDK)) for kernel bypass. Also, the interface between a master node and a worker node may be connected to a tunneling interface through a bridge, and may be connected to a network configured with an existing overlay network.

The network gateway may perform a multi-cluster tunneling connection function of layer L3.

A global (data) repository management function is a storage function to create high-speed shared storage by utilizing a network-based storage system using a memory-based repository and to share data by connecting the high-speed shared storage to a local shared cache, and storage in the master node may be used as the network-based shared storage.

The routing agent may be executed in all nodes, may configure a path using endpoint resources synchronized with other clusters, and may enable the connection between all of the clusters. Here, the rules of Iptable may be set. The routing agent may have the routing table of the gateway engine in order to connect to and communicate with the gateway engine.

The global manager node 80 may use a method of a global scheduler (a global integration manager + a controller + a node agent).

The global manager node 80 may obtain cluster information by accessing the local orchestrator in the master of each cluster for global management or transfer commands for creating a virtual machine and a container to the VM-container integration manager of a corresponding node.

The global manager node 80 may further include components related to a complex orchestrator.

The global manager node 80 may further include a global orchestration REST API that requests allocation of a virtual machine and a container from a user interface or a command tool.

The global manager node 80 may further include a global orchestration handler, which is a component for handling the global orchestration REST API.

The global manager node 80 may further include a request queue manager, which is a component for receiving a request to allocate a VM and a container from the global orchestration handler and storing and managing the data.

The global orchestration controller of the global manager node 80 may be a component that pulls orchestration request data from a request queue and creates and executes a global orchestration task thread.

The global manager node 80 may further include a global orchestration task thread that converts a scheduler task into a message format to be transferred to the global scheduler agent of a corresponding master node and stores the same in a task message queue.

The global manager node 80 may further include a cluster metadata repository for storing cluster-related metadata.

The global manager node 80 may further include a task message queue, which is a repository for storing orchestration task messages between a command executor and a cluster.

The global manager node 80 may further include a global orchestration agent, which is a component that receives an orchestration task message corresponding thereto from the task message queue of the master node of the cluster and calls a REST API.

The global manager node 80 may further include a cloud scheduler, which is a component that detects undeployed virtual machines and containers and selects the worker node to execute the container.

The distributed cloud system and the apparatus for integrated image management for virtual machines and containers in a cloud-computing environment according to an embodiment of the present disclosure may provide services by integrating virtual machines and containers in a cloud-computing environment.

The distributed cloud system and the apparatus for integrated image management for virtual machines and containers in a cloud-computing environment according to an embodiment of the present disclosure may perform management such that virtual machines and containers can be used in an integrated manner.

The distributed cloud system and the apparatus for integrated image management for virtual machines and containers in a cloud-computing environment according to an embodiment of the present disclosure may isolate various applications or services. An integrated environment for virtual machines and containers may improve security and stability by isolating various applications or services from each other.

The distributed cloud system and the apparatus for integrated image management for virtual machines and containers in a cloud-computing environment according to an embodiment of the present disclosure may conserve resources. The integrated environment for virtual machines and containers may conserve resources by sharing the same underlying hardware.

The distributed cloud system and the apparatus for integrated image management for virtual machines and containers in a cloud-computing environment according to an embodiment of the present disclosure may simplify management. The integrated environment for virtual machines and containers may simplify management by providing a consistent method of deploying and managing applications.

The distributed cloud system and the apparatus for integrated image management for virtual machines and containers in a cloud-computing environment according to an embodiment of the present disclosure may provide easy adoption of legacy environments. The integrated environment for virtual machines and containers may facilitate adoption of legacy virtual machines or containers.

The distributed cloud system and the apparatus for integrated image management for virtual machines and containers in a cloud-computing environment according to an embodiment of the present disclosure may provide a high-performance architecture for efficient collaboration between clusters.

The distributed cloud system and the apparatus for integrated image management for virtual machines and containers in a cloud-computing environment according to an embodiment of the present disclosure may configure a high-performance container using a memory-based storage device for improving the efficiency of a container and configure a global cache for data linkage between containers.

The distributed cloud system and the apparatus for integrated image management for virtual machines and containers in a cloud-computing environment according to an embodiment of the present disclosure may provide a high-speed network connection between multiple clusters.

The distributed cloud system and the apparatus for integrated image management for virtual machines and containers in a cloud-computing environment according to an embodiment of the present disclosure may establish a tunneling-based high-speed network for collaborative services between clusters.

The distributed cloud system and the apparatus for integrated image management for virtual machines and containers in a cloud-computing environment according to an embodiment of the present disclosure may provide optimal management technology for clusters for integrated management of virtual machines and containers over interconnected networks.

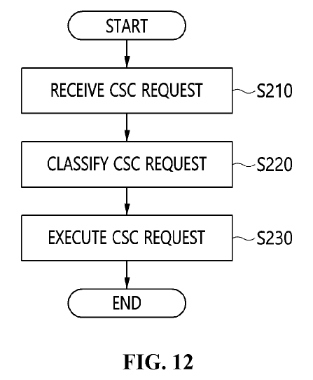

FIG. 12 is a flowchart illustrating a method for integrated image management for virtual machines and containers in a cloud-computing environment according to an embodiment of the present disclosure.

Referring to FIG. 12, in the method for integrated image management for virtual machines and containers in a cloud-computing environment according to an embodiment of the present disclosure, first, a request of a CSC may be received at step S210.

That is, at step S210, a request (command) may be received from a user (the interface of the CSC).

Here, at step S210, the computing node that uses a computing resource may receive the request of the user.

In the method for integrated image management for virtual machines and containers in a cloud-computing environment according to an embodiment of the present disclosure, the request of the CSC may be classified at step S220.

That is, at step S220, the request (command) of the user may be transmitted to any one of a virtual machine management handler 120 and a container management handler 130 by classifying the request depending on whether it corresponds to VM management or container management.

Here, at step S220, the received request of the user may be classified depending on the type of the virtualization machine of the computing resource.

Here, at step S220, the desired state of a VMI (which is defined in the VMI) may be continuously compared with the actual state of a hypervisor in order to adjust the desired state and the actual state.

Here, at step S220, when there is a discrepancy between the desired state and the actual state, a necessary measure may be taken to adjust the discrepancy.

Here, at step S220, a task such as creating, starting, stopping, updating, or deleting a VM may be performed based on a predefined VMI configuration.

Here, at step S220, interaction with other components for integrated management of a virtual machine and a container is not independently performed, and a VM task may be performed in collaboration with the components for integrated management of a virtual machine and a container, such as the handlers 120 and 130 and an executor 140.

Here, at step S220, in order to start a new VM, a guideline for managing the actual VM in the hypervisor may be sent to the handlers 120 and 130 while coordinating with a launcher.

Here, at step S220, the connection between a virtual machine instance (VMI) and a Kubernetes pod may be facilitated through pod connection processing. Accordingly, the pod may smoothly integrate virtualized workloads by interacting with a specific VM.

Here, at step S220, a VM-container integration controller 110 may receive the request of the CSC and transmit the same to the virtual machine and container executor 140.

Here, at step S220, the initial specifications of a virtual machine and a container may be received, and a signal to start any one of the virtual machine and the container corresponding to each execution program may be sent.

Here, at step S220, the lifecycle of the virtual machine and container and communication thereof with the host OS, such as network traffic forwarding, may be managed.

Here, at step S220, Virtual Machine Instances (VMIs) may be managed in the integrated management of virtual machines and containers.

Here, at step S220, VMI lifecycle management may be performed.

That is, at step S220, a container-based virtualization machine and a hybrid virtualization machine may be managed in an integrated manner.

The container-based virtualization machine may virtualize and provide an application that is containerized by being installed in a first virtualization machine that virtualizes the computing resource.

The hybrid virtualization machine may virtualize and provide an application that is containerized by being installed in a second virtualization machine that virtualizes the computing resource and/or virtualize and provide an application containerized on the computing resource.

Here, at step S220, the request of the user may be received and provided to a first interface of the container-based virtualization machine and a second interface of the hybrid virtualization machine, and virtualization of the computing node may be managed in an integrated manner.

Here, at step S220, the received request of the user may be classified depending on the type of the virtualization machine, and the request of the user, which is classified depending on the type of the virtualization machine, may be provided to the first interface or the second interface.

Here, the container-based virtualization machine and the hybrid virtualization machine may be installed in an OS kernel in the computing node.

Here, at step S220, an image management function for the container-based virtualization machine or the hybrid virtualization machine may be provided depending on the image management function installed in the OS kernel in the computing node.

Here, at step S220, the container-based virtualization machine or the hybrid virtualization machine may be managed based on a library on an OS in the computing node or through a software daemon in the computing node.

Also, in the method for integrated image management for virtual machines and containers in a cloud-computing environment according to an embodiment of the present disclosure, the request of the CSC may be executed at step S230.

That is, at step S230, when a VMI is created through an API, a VMI specification may be received, and a VM may be executed by sending a signal to an execution program, which is another component.

Here, at step S230, interaction with the underlying hypervisor is performed using a library, and the VM may be configured and started based on detailed information about the VMI.

Here, at step S230, the state of the VM that is being executed may be continuously monitored.

Here, at step S230, a signal (e.g., a crash) may be received from the VM, and the VMI state may be updated in the API based thereon.

Here, at step S230, the VM may be safely stopped or terminated when there is an instruction.

Here, at step S230, the controller and the VM container may be bridged.

Here, at step S230, a communication bridge between the cluster and a guest VM may be established.

Here, at step S230, functions, such as real-time migration, console access, and network traffic transfer between the VM and the container, may be used.

Here, at step S230, when the API (e.g., resource allocation) is changed by the desired state of the VMI, agent update by which the change is converted into adjustment of the VM itself and by which whether the adjustment matches the desired configuration is checked may be performed.

Here, at step S230, an autonomous heartbeat mechanism is implemented, whereby unresponsive nodes in the cluster may be detected.

Here, at step S230, a security function may be designed as a single authorized component in the integrated management of virtual machines and containers.

Here, at step S230, sensitive tasks such as VM creation and configuration that require root access may be processed.

Here, at step S230, using the software installed in the OS kernel, the virtual machine and the container may be executed depending on the request of the CSC.

Here, at step S230, various types of interface methods to be executed to start the virtual machine and the container may be supported.

Here, at step S230, in order to provide cgroup and namespace, a guideline may be sent to a controller agent through an API when the Virtual Machine Instance (VMI) is created. According to the guideline, an instance may be created specifically for the corresponding VMI at step S230. In the instance, the underlying container may execute an execution program.

Here, at step S230, control groups (cgroup) and namespace required for a VM process may be provided as the primary role of a launch manager. This may be a primary kernel mechanism for isolating and controlling resources (CPU, memory, etc.) for individual VMs and network visibility.

Here, at step S230, the initial environment of the VM may be configured.

Here, at step S230, the initial VM environment (cgroup, namespace, configuration) may be set.

Here, step S230 may be performed in the VM instance itself. On the other hand, the handlers 120 and 130 may interact directly with the hypervisor, and the controller 110 may supervise VMI management at a higher level in the API.

Here, at step S230, based on interaction with libraryt, the execution program may manage VM creation and configuration in the underlying hypervisor (e.g., KVM) through the library.

Here, at step S230, the resources and configuration of the VM may be defined using the VMI specification.

Here, at step S230, in-memory-based storage and an in-memory-based container structure may be used in order to use data and storage between the container and the VM.

Among the usage models of virtual machines and containers, models configured in a single node may include a host-based virtualization model and a container-based virtualization model.

In the case of a hybrid virtualization model, a virtual machine is considered a node and may be connected to another virtual machine having a container.

Here, at step S230, an image manager for storing and managing data for image management is present for both the container and the virtual machine, and the performance of the virtual machine and container may be improved using various types of high-performance storage (memory, NVMe, SSD, federation storage, etc.).

Here, at step S230, an in-memory-based container storage system may be used as a repository for configuring a virtual machine image or a container file system (an additional function for image management).

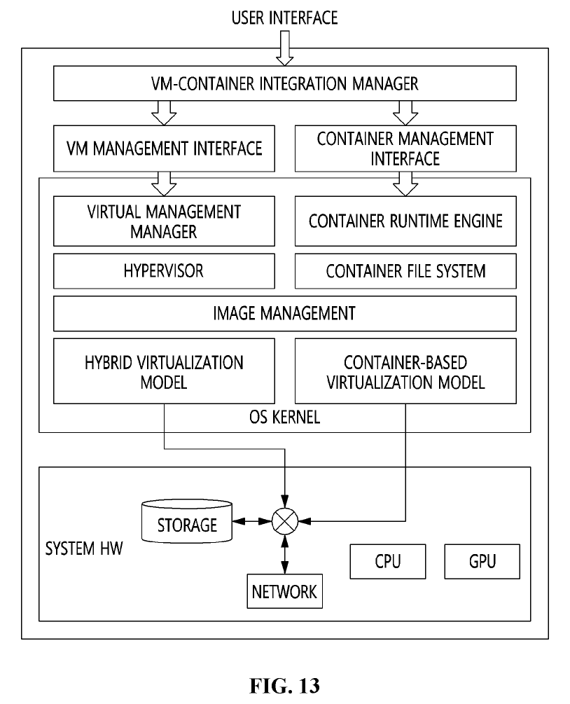

FIG. 13 is a block diagram illustrating an integrated management structure for virtual machines and containers based on multiple clusters in an apparatus for integrated image management for virtual machines and containers in a cloud-computing environment according to an embodiment of the present disclosure.

The apparatus for integrated image management for virtual machines and containers in a cloud-computing environment illustrated in FIG. 13 corresponds to the apparatus for integrated image management for virtual machines and containers in a cloud-computing environment illustrated in FIG. 4, and it can be seen that a hybrid virtualization model and a container-based virtualization model are used.

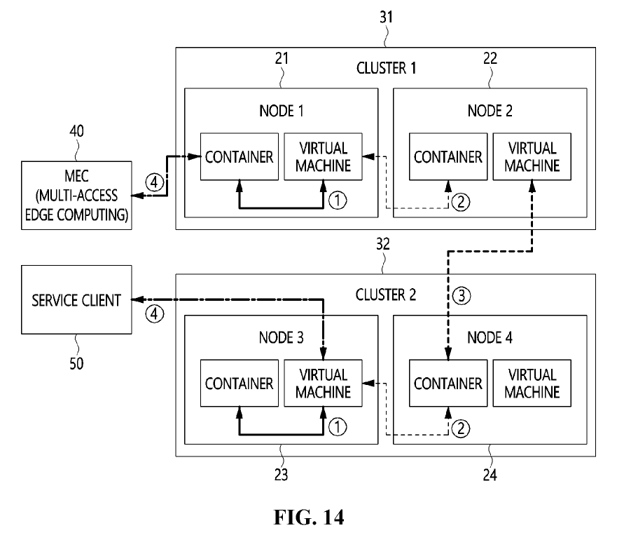

FIG. 14 is a view illustrating network connection types of heterogeneous virtual environments based on an edge-computing configuration according to an embodiment of the present disclosure.

Referring to FIG. 14, the model proposed in the present disclosure may provide network connection types of heterogeneous virtual environments depending on the edge-computing configuration, as described above.

An application service may be run in the form of a virtual machine or a container in each node depending on the execution type. Generally, homogeneous virtual environments within the same node are configured with a virtual network that supports Network Address Translation (NAS) to provide network connections between virtual machines and between containers, as well as internal and external communication.

However, heterogeneous virtual environments are disconnected from each other because a different network device is connected to each virtual environment and because the bands of the connected networks differ from each other.

The first type of network connection illustrated in FIG. 14 enables a network connection between heterogeneous virtual environments in a single node.

The second type of network connection enables a network connection between services running on virtual environments in different nodes.

The second type of network connection may include all network connections between a virtual machine in node 1 (21) and a virtual machine in node 2 (22), between a virtual machine in node 1 (21) and a container in node 2 (22), and between a container in node 1 (21) and a container in node 2 (22).

Meanwhile, in order to improve execution performance or to secure resources when resources are insufficient to run the service having the same purpose, two or more nodes may be configured in the form of clusters.

In order to support service collaboration, migration, and re-execution between the configured clusters, a method for allowing the internal virtual environment to be accessed from outside the cluster may be provided.

Also, when a service is provided through multiple clusters, Multi-Access Edge Computing (MEC), which supports latency reduction and real-time performance of a high-bandwidth service by analyzing, processing, and storing data at a network edge, operates, and a network connection between the virtual environment within the cluster and the MEC may be provided.

A virtual machine may be a Kernel-based Virtual Machine (KVM) of the Linux OS, and a container may be configured as a Docker developed using LinuX Container (LXC), which is a kernel container of the Linux OS.

The virtual machine and the container respectively use virbr0 and docker0, which are virtual network devices, whereby the virtual environments may be connected to the physical network device of the node. Each virtual network device basically performs a bridge operation and may provide a network connection between homogeneous virtual environments, such as between containers or between virtual machines, through a NAT function. Each time a container or a virtual machine is generated, it may be assigned an individual IP address within a network band set in the virtual network device through a Dynamic Host Configuration Protocol (DHCP). When there are no particular settings, 172.17.0.0/16 and 192.168.122.0/24 may be set as the default network bands of a Docker and a KVM, respectively.

The connection between the virtual network device and the virtual machine or the container uses a Virtual Ethernet Interface (veth) of the Linux OS. The veth is generated as a pair and may be configured with a network device within the virtual machine or container and the network device of the node to be connected to virbr0 or docker0 (veth d34dc1d@if6, veth c22dr2d@if7, vnet5, or vnet6).

In the above-described structure, the network connection between the container and the virtual machine is disconnected because the virtual network device and network band connected and managed for containers differ from those for virtual machines. If the network bands of docker0 and virbr0 are set to the same network band such that the heterogeneous virtual environments appear to belong to the same network, an IP address conflict may occur because a DHCP function is performed by different entities when a container and a virtual machine are generated.

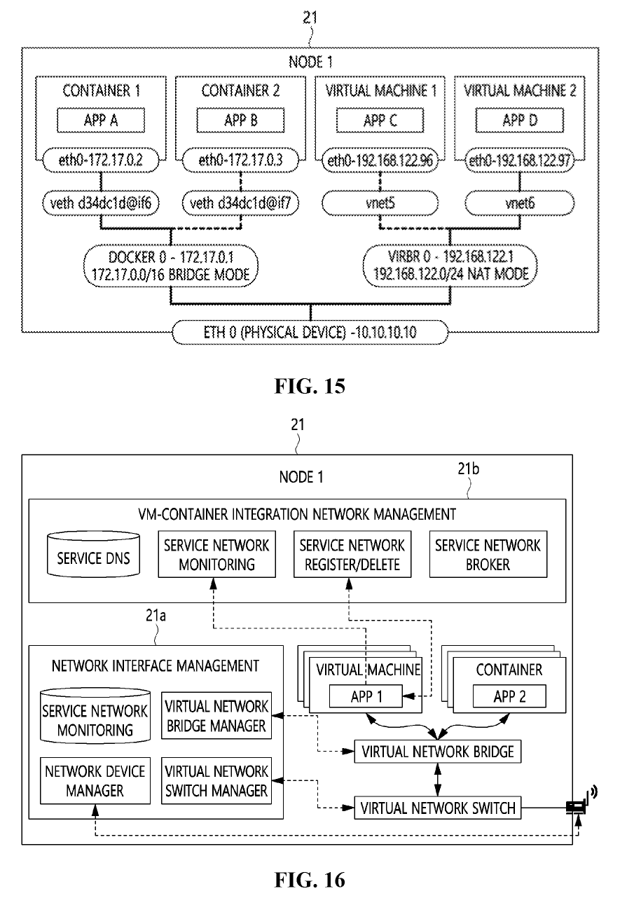

FIG. 15 is a view illustrating a network connection structure for heterogeneous virtual environments in a single node according to an embodiment of the present disclosure.

Referring to FIG. 15, it can be seen that a virtual machine is a Kernel-based Virtual Machine (KVM) of the Linux OS and a container is configured as a Docker developed using LinuX Container (LXC), which is a kernel container of the Linux OS.

The virtual machine and the container respectively use virbr0 and docker0, which are virtual network devices, whereby the virtual environments may be connected to the physical network device of the node.

Each virtual network device basically performs a bridge operation and may provide a network connection between homogeneous virtual environments, such as between containers or between virtual machines, through a NAT function.

Each time a container or a virtual machine is generated, it may be assigned an individual IP address within a network band set in the virtual network device through a Dynamic Host Configuration Protocol (DHCP). When there are no particular settings, 172.17.0.0/16 and 192.168.122.0/24 may be set as the default network bands of a Docker and a KVM, respectively.

The connection between the virtual network device and the virtual machine or the container may use a Virtual Ethernet Interface (veth) of the Linux OS. The veth is generated as a pair and may be configured with a network device within the virtual machine or container and the network device of the node to be connected to virbr0 or docker0.

However, the network connection between the container and the virtual machine may be disconnected because the virtual network device and network band connected and managed for containers differ from those for virtual machines. If the network bands of docker0 and virbr0 are set to the same network band such that the heterogeneous virtual environments appear to belong to the same network, an IP address conflict may occur because a DHCP function is performed by different entities when a container and a virtual machine are generated.

Accordingly, in the present disclosure, the virtual network devices separated for each type of virtual environment, as shown in FIG. 5, may be integrated and operated as a single device in a single node.

A container or virtual machine executed in the same node may be assigned an IP address by a single virtual network device that is preset.

Accordingly, a single device is configured to execute the DHCP for both the container and the virtual machine, so there is no network overlap between the virtual environments.

The heterogeneous virtual environments belong to the same network band, so they may communicate with each other. Fundamentally, a Docker and a KVM may operate by establishing a rule for network packet transfer in iptables for the kernel firewall of the Linux OS.

Here, the Docker and the KVM modify the packet transfer rule for docker0 and virbr0 such that when it is set to a container, the virtual machine is connected to the docker0 virtual network device, whereas when it is set to a virtual machine, the container is connected to the virbr0 virtual network device.

FIG. 16 is a block diagram illustrating function blocks of a worker node according to an embodiment of the present disclosure.

Referring to FIG. 16, the role of each function block of a worker node may be described as follows.

The heterogeneous virtual environments in the node may be connected via a virtual network bridge.

The virtual network bridge may support network connections between virtual environments, such as docker0 of a Docker and virbr0 of a KVM, and allocate or release an IP address when a virtual environment is generated or deleted.

A virtual network switch may be configured between the virtual network bridge and the physical network device of the node.

The virtual network switch may be used to operate separate virtual networks for network access to virtual environments run in different nodes.

A network interface management unit 21a may manage information about a virtual network device of a single node and a network between nodes.

Each of a virtual network bridge manager and a virtual network switch manager may perform generation, configuration, deletion, and monitoring for a virtual network device in the node.

A network device manager may collect network information pertaining to the physical network device of the node for connection to the virtual network device.

Here, the network device manager may collect the name of the device and the IP address assigned to the device and monitor a network traffic state.

When an edge-computing environment is operated across multiple nodes, the network device manager may allocate a network band of the generated virtual network devices so as not to overlap the network bands of other nodes.

The network device manager may use a virtual network routing table in order to configure a suitable network path in response to a request form the service running on the virtual environment.

The table is implemented as a database and may receive the network information from the network device manager.

A service network management unit 21b may register and delete network information of the service run on the virtual environment and monitor whether the service is running.

The related data may be used to access the corresponding service from both inside and outside the node or cluster, depending on the scale of the service operated in edge computing.

A service broker accesses the virtual network routing table of the network interface management unit 21a, thereby checking whether information about the service to be accessed is present.

Here, when the corresponding service is not present in the same node, the service broker may request the service broker of another node to provide information about the service to be accessed.

Here, when the network path of the service is identified, the service broker may store the information in a service Domain Name Service (DNS).

Here, the service broker may retain the corresponding information for a certain period, and when the retention period expires, the service broker may discard the data and may reconfigure data in response to a new service access request.

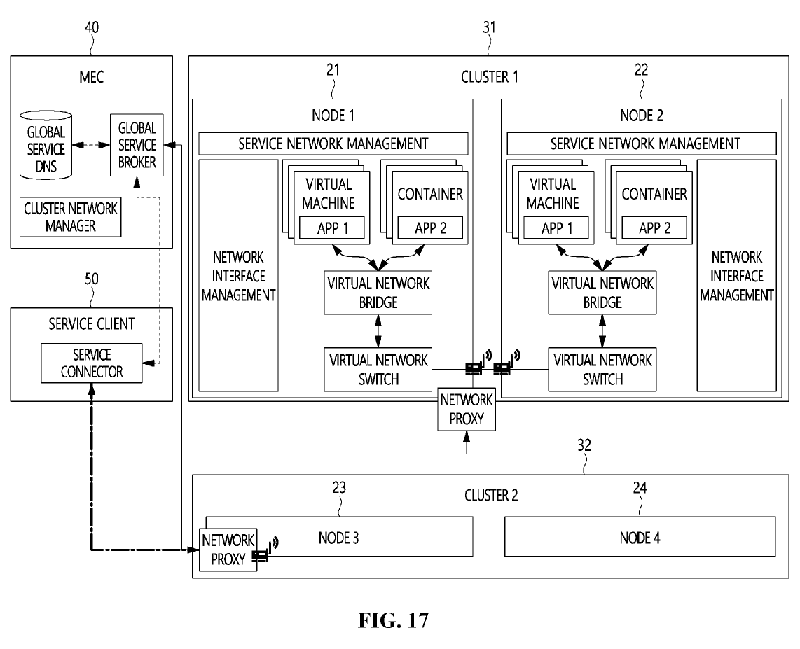

FIG. 17 is a view illustrating a network connection configuration for heterogeneous virtual environments between multiple clusters according to an embodiment of the present disclosure.

Referring to FIG. 17, it can be seen that a model that configures two or more nodes 21, 22, 23, and 24 as clusters 31 and 32, provides a network connection between the clusters 31 and 32 and an MEC 40 for managing the network connection, and allows a service client 50 outside the cluster to access an internal virtual environment is illustrated in the network connection configuration for heterogeneous virtual environments between multiple clusters.

Here, the MEC 40, cluster 1 (31), and cluster 2 (32) may be located in different geographical regions and configured in different networks.

When nodes are configured as clusters, the service network management unit and network interface management unit, described with reference to FIG. 16, may be operated for each node. One of the nodes in each cluster may be executed as a master node.

Here, a network proxy may be used to access the cluster.

When a network packet destined to a service running on a virtual environment in the node reaches the cluster, the network packet may be forwarded to the physical network device of the master node.

The access information of each network proxy may be managed by the cluster network manager of the MEC 40. When a cluster is configured, network proxy information may be registered in the MEC 40.

The global service broker of the MEC 40 may provide network information for access to a service running on a virtual environment.

When a service is configured, network information for the service may be registered in the global service DNS of the MEC 40.

The information that is used includes an IP address and a domain name for specifying the service.

The service client 50 may make a request for information for service access to a service connector within the client.

The service connector may transfer the request to the global service broker of the MEC 40.

The global service broker may identify a DNS and provide information about the cluster in which the service is located to the user in the form of a domain name.

The user may access the network proxy of the cluster using the domain name.

The above-described global service broker may interact with a service broker that operates for each node in the cluster.

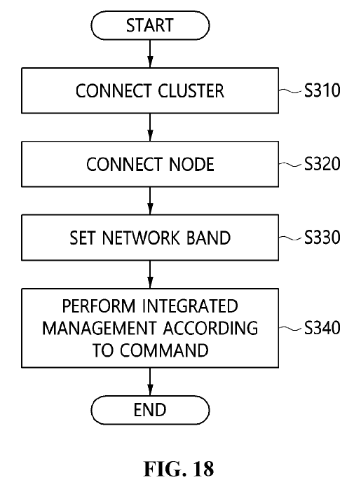

FIG. 18 is a flowchart illustrating a method for managing a multi-cluster service network based on heterogeneous virtual environments according to an embodiment of the present disclosure.

Referring to FIG. 18, in the method for managing a multi-cluster service network based on heterogeneous virtual environments according to an embodiment of the present disclosure, first, clusters may be connected at step S310.

That is, at step S310, a network between clusters, each including multiple nodes, may be connected using tunneling.

Here, the multiple nodes included in the clusters may include a single master node and multiple worker nodes for each cluster.

Also, in the method for managing a multi-cluster service network based on heterogeneous virtual environments according to an embodiment of the present disclosure, a network between nodes included in different clusters may be connected at step S320.

That is, at step S320, the network between nodes included in different clusters, among the clusters, may be connected using a virtual network layer of L3 layer.

Here, at step S320, the network between the nodes included in different clusters may be connected using an L3 VxLAN tunnel between the virtual network switches included in the nodes.

Here, at step S320, the virtual network switch and a virtual network bridge included in the nodes may be connected as a veth pair.

Here, at step S320, the virtual network switch may set a VxLAN Tunnel End Point (VTEP), which corresponds to the endpoint of the VxLAN tunnel, to indicate the IP address of an external node.

Also, in the method for managing a multi-cluster service network based on heterogeneous virtual environments according to an embodiment of the present disclosure, a network band for a virtual machine and a container may be set at step S330.

That is, at step S330, the heterogeneous virtual environments of the virtual machine and container included in the nodes may be set to belong to the same network band.

Here, at step S330, a single IP address may be integrally assigned to the virtual machines and containers included in the nodes by any one virtual network device preset for each of the nodes.

Also, in the method for managing a multi-cluster service network based on heterogeneous virtual environments according to an embodiment of the present disclosure, integrated management may be performed depending on the command received from a user at step S340.

That is, at step S340, a packet including the command is received from the user, whereby integrated management of the virtual machine and container included in the nodes may be performed.

Here, at step S340, the virtual network switch forwards the packet to the virtual network bridge according to a preset rule, whereby the packet may be processed in the virtual environment.

Here, at step S340, the virtual network switch may transfer the packet to the virtual network switch of another node via the VxLAN tunnel.

Here, at step S340, the master node may transfer the command received from the user to the worker nodes using any one of a virtual machine controller and a container controller.

Here, at step S340, the worker nodes receive the command through the integration manager, thereby managing the virtual machine and the container through any one of a virtual machine management interface and a container management interface.

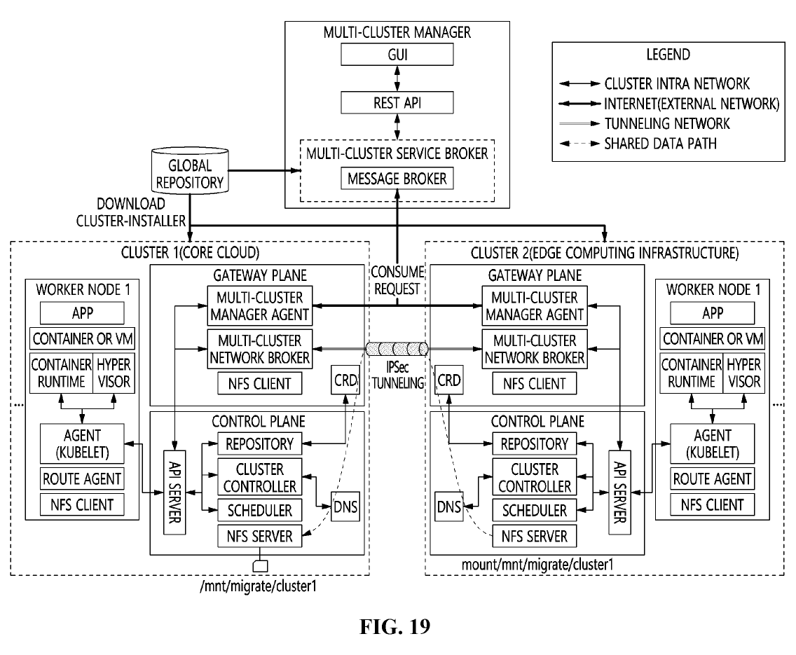

FIG. 19 is a view illustrating a multi-cluster manager according to an embodiment of the present disclosure.

Referring to FIG. 19, the multi-cluster manager may correspond to the global manager illustrated in FIG. 11, and the multi-cluster manager agent may correspond to the virtual machine-container integration controller illustrated in FIG. 11.

The multi-cluster manager may connect systems between two clusters (K8s) and manage the same. An edge-computing infrastructure may include a computer node, a server, a small device, a network device having a computation capability, a clustered node, and the like. In FIG. 19, Cluster1 or Cluster2 may be a Kubernetes environment. In another example, Cluster1 or Cluster2 may be a public or private cloud environment of a cloud-computing environment. In FIG. 19, the control plane may be configured in the infrastructure of both cloud and on-premises environments.

In a container-based platform (Kubernetes, etc.), a VM may be used by deploying a virtual machine integration agent, and in a virtual machine-based platform (OpenStack, etc.), a container workload may be executed and managed by installing a container integration agent.

The multi-cluster manager may include a GUI unit, a REST API server, and a multi-cluster service broker.

The apparatus for multi-cluster-based cloud-computing connection management according to an embodiment of the present disclosure may correspond to the multi-cluster service broker.

The multi-cluster service broker may perform core-edge and edge-edge connection functions.

Here, the multi-cluster service broker is one of K8s clusters in which a Custom Resource Definition (CRD) is present, which is required to store cluster information in a repository (e.g., K8s etcd) in order to connect multiple clusters over a network, and the multi-cluster manager in which the multi-cluster service broker is installed may perform a network connection function.

The GUI unit may provide a user interface for managing multiple clusters.

Each of the clusters may include a control plane (control node), a gateway plane (gateway node), and a worker node.

The control plane may be configured in the master node of a basic cluster (K8s) or a single node.

The control plane may include a DNS server, an API server, a repository, a cluster controller, and a scheduler.

The DNS server may correspond to a cluster network DNS server.

The API server may provide cluster-related commands and a multi-cluster connection function.

The repository may correspond to a key-value data store (e.g., K8s etcd).

The cluster controller may provide control functions (e.g., kubeadm, etc.) for cluster management.

The scheduler may correspond to a scheduler for cluster load balancing.

The gateway plane may be configured within the control plane or may be placed anywhere in the cluster.

The gateway plane may include a multi-cluster manager agent, a multi-cluster network broker, and a Network File System (NFS) client.

The multi-cluster manager agent may execute an agent program for performing commands through a multi-cluster manager and a message broker.

The multi-cluster network broker may provide a network connection between clusters and a gateway (e.g., Submariner).

The multi-cluster network broker may include a broker, a route agent unit, a service discovery unit, a gateway engine unit, and a global network unit.

The broker may include a CRD and exchange metadata between gateway engines (mutual discovery).

The route agent unit may perform cross-cluster traffic routing from a node to a gateway engine.

The service discovery unit may support a DNS-based service lookup and service registration in the cluster.

The gateway engine unit may manage a secure tunnel for a network connection to another cluster (IPSec connection).

The global network unit (Global net) may process interconnection between clusters, the CIDR of which overlap each other.

The worker node may include an agent unit, a route agent unit, an NFS client unit, and a container runtime unit.

The agent unit may process a command for controlling the worker node, which is received from the cluster controller, and may manage the worker node (e.g., kubelet).

The route agent unit may provide a router engine for connecting the inside of the cluster and the gateway.

The container runtime unit may provide an interface for executing a container.

FIG. 20 is a block diagram illustrating an apparatus for integrated image management for virtual machines and containers in a cloud-computing environment according to an embodiment of the present disclosure.

Referring to FIG. 20, a CI/CD trigger engine 51 may detect a code change event, such as a source code update or version control synchronization, and activate (trigger) a build process for automatically generating an image.

Here, the CI/CD trigger engine 51 operates in conjunction with a Git-based code repository (GitHub, GitLab, or the like) and initiates a build trigger for automatically generating an image when an event, such as push, merge, schedule, or the like, occurs. The trigger is connected with a common template and may transfer image configuration information (Dockerfile, Packer templates, or the like) suitable for each virtual instance.

Base templates are referenced when the trigger is initiated, and may provide predefined configuration specifications (Dockerfile, Packer templates, etc.) for generating virtual machine and container images.

A unified package generator 52 may coordinate and manage integrated image generation for two types of virtualization formats (a container and a virtual machine).

The unified package generator may include a package generation controller, a container image builder, a VM image builder, an image optimizer, and an image scanner.

The package generation controller may appropriately assign request commands received from an API to the container image builder and the VM image builder and control the same.

The container image builder and the VM image builder may build (generate) a container image and a virtual machine image, respectively, based on the received templates.

The image optimizer may perform an optimization process by removing duplicate components from the generated images, applying compression, and operating in conjunction with an internal cache controller to minimize resource usage.

The image scanner may check the generated images for security vulnerabilities or inconsistencies, and when a security policy is violated, it may stop deployment or require a separate approval procedure.

A secure image registry 53 may manage and store all validated virtual machine and container images in an integrated manner and provide metadata for consistency and traceability together with version control functions.

Here, the secure image registry 53 may manage container and virtual machine images in an integrated manner and may contain image versions and metadata of each of the images. Then, the images are deployed through an integrated executor, and may be applied to container execution environments (Kubernetes, etc.) and virtual machine execution environments (libvirt, KVM, etc.).

An image manager may assign the final image stored in the registry 53 to an appropriate execution platform depending on the image type (a container or a virtual machine) and direct the deployment of the image.

A cloud computing infrastructure 54 is provided by a cloud service provider (CSP), and may configure an actual container runtime environment or virtual machine hosting environment based on the received image and execute an application (workload).

Also, the apparatus for integrated image management for virtual machines and containers in a cloud-computing environment according to an embodiment of the present disclosure will be described below through a use case of generating virtual machine-container images using CI/CD.

The apparatus for integrated image management for virtual machines and containers in a cloud-computing environment according to an embodiment of the present disclosure may provide an automated CI/CD-integrated approach to generate, verify, and deploy images in environments that utilize both virtual machines and containers. This may ensure that application changes are reflected in executable images across a hybrid infrastructure based on virtual machines and containers through a seamless pipeline.

The apparatus for integrated image management for virtual machines and containers in a cloud-computing environment according to an embodiment of the present disclosure may provide integrated generation and deployment of virtual machine and container images based on CI/CD. When an event occurs due to a code change in a cloud service customer/node (CSN), container images and virtual machine images may be automatically generated based on a template. The generated images are stored in a common repository. Here, the generated images may be optionally stored after undergoing security checks or optimizations. The CSN may distribute the stored images to the infrastructure integrated with virtual machines and containers, provided by a cloud service provider (CSP).

The CI/CD trigger engine 51 may initiate a process when a code change event, such as a source update or version control synchronization, is detected.

Here, the CI/CD trigger engine 51 may activate the image build process based on the event.

When base templates are activated, a set of predefined build templates may be referenced. The templates may contain configuration specifications for generating virtual machine and container images.

The unified package generator 52 may coordinate the generation of images for two types of virtualization formats.

Here, the unified package generator 52 assigns commands entered by a request from an API to the container image generator and the virtual machine image generator, thereby generating images.

Here, the unified package generator 52 applies an optimization process after image generation, and the optimization process may include removing duplicate components, applying compression, and an internal caching mechanism to minimize resource usage.

Also, an optional step to inspect the images to detect security vulnerabilities or inconsistencies may be included. When a policy is violated, deployment may be stopped or a flag may be set for approval.

The secure image registry 53 may store all validated images.

Here, the secure image registry 53 may include secure deployment across the environments, metadata for traceability and consistency, and two types of virtualizations with a version control function.

An execution infrastructure includes a deployment engine, which may assign the final image to an appropriate execution platform. Depending on the image type, the final image may be deployed to a container runtime environment or a virtual machine hosting environment.

The target infrastructure may include clustering or distributed systems depending on the configuration and policy.

A cloud service network (CSN) may design cloud services capable of generating both virtual machine and container images based on unified build templates.

Here, the CSN may compose image generation flows such that both virtual machines (VMs) and containers are simultaneously produced from input of a common configuration.

Here, the CSN may use a standardized template to define build metadata and image configurations for both virtual machines and containers.

Here, the CSN may conduct testing before deploying generated images to a CSP.

The test of the generated images may include validation for image integrity and functional readiness in a pre-deployment environment mirroring the target infrastructure.

The CSN may package the validated images and associated metadata and deliver the metadata to the CSP through a secure and verifiable interface.

The CSN may incorporate an optimization mechanism including deduplication and caching in an image generation pipeline.

The CSN may support security inspection capabilities for the generated images and flag any policy-violating artifacts before delivery.

The CSP may provide runtime environments for executing container or VM images according to a deployment request and the type of the received image.

The CSP may provide deployment interfaces that accept validated images from the CSN and assign the same to a proper execution engine (based on a container or VM).

The CSP may ensure resource isolation across compute, storage, and network resources to securely execute the assigned image.

The CSP may provide clustering and scaling mechanisms to support distributed deployment of workloads provided by the CSN.

The CSP may provide a cloud service user (CSU) with a unified interface enabling the design, provisioning, and lifecycle management of cloud services that incorporate both virtual machines (VMs) and containers.

The unified interface may support operations such as resource specifications, deployment templates, dependency mapping between VMs and containers, and integrated orchestration workflows.

The CSP may support an integrated runtime environment on a single node in which both a hypervisor and a container runtime engine are jointly orchestrated to concurrently run VMs and containers by using shared scheduling, networking, and storage interfaces.

The CSP may support provisioning of composite cloud services in which VMs and containers are orchestrated together based on a service deployment request from the CSC.

The cloud services may include the capabilities of cloud services defined in ITU-T Y.3502.

For example, when deploying a web application, the CSC may request the frontend to run in containers and the backend database to run on a VM. In this case, the CSP may process the request by provisioning the same as a single integrated cloud service through a unified deployment request, a common service template, and a consolidated management interface.

The CSP may provide image conversion capabilities that allow applications running on a VM to run on a container or allow applications running on a container to run on a VM.

The image conversion capabilities mean image transformation between a container image and a VM image.

The CSP supports policy-driven resource allocation for VM-container integration environments, allowing compute, network, and storage resources to be provisioned concurrently to both VMs and containers based on specific requirements of each application workload.

For example, when deploying an application, the CSC may request different resource characteristics for each component of the workload, such as allocating high-performance storage and extended memory to a VM hosting a database, while assigning a scalable CPU and high network throughput to a container-based frontend service. The CSP may handle this request through a unified provisioning process that simultaneously allocates and orchestrates resources across both environments under a single management interface.

The CSP may provide a unified management interface that enables consistent lifecycle operations for both VMs and containers within the integrated environment.

The consistent lifecycle operations may include generation, monitoring, scaling, updating, and termination.

The CSP may provide comprehensive monitoring capabilities for applications deployed across VM-container integration environments, including metrics such as operational status, resource utilization, performance indicators, and inter-component dependencies.

The CSP may provide a global integration controller for managing multiple clusters composed of nodes supporting VM and container integration.

The global management may provide management capabilities for massively distributed nodes in order to improve user experience, as described in [ITU-T Y.3538].

The global integration may provide end-to-end management operations, such as secure registration of new clusters, authentication and authorization for inter-cluster communication, remote command execution and configuration propagation, and real-time monitoring of resource utilization and status across clusters.

The global integration controller may deploy, maintain, and manage a VM-container integration controller within each registered cluster and ensure consistent control and lifecycle management of VMs and containers under a unified policy.

The CSP may support automated registration and initialization of new clusters after detection of VM-container integration models.

Upon registration, the global integration controller may generate a unique cluster identifier (UUID), issue a secure server access token, and prepare deployment instructions for the VM-container integration controller, which are delivered via a communication broker.

Upon execution of the deployment instruction, a VM-container integration controller image preregistered in an external repository is pulled into a local image repository, after which the VM-container integration controller may be launched within the control plane of the corresponding cluster and initialized for integrated management.

The CSP may provide deployment instructions for pulling preregistered images from the secure global repository into the local repository of the cluster for VM and container images.

The CSP may ensure continuous connectivity monitoring across clusters to support integrated VM and container operations.

The VM-container integration controller in each cluster transmits heartbeat or connection status information to a centralized management system at regular intervals, thereby providing coordinated VM-container communication across a multi-cluster environment.

Upon detecting a connection failure, the VM-container integration controller halts transmission and triggers a connection failure notification, thereby enabling fault detection and recovery mechanisms.

The CSP may provide each node with a node-level VM-container integration controller agent for executing internal modules for command execution, connection monitoring, configuration management, resource monitoring, and multi-cluster network oversight.

The VM-container integration agent may directly communicate with the VM-container integration controller.

The CSP may provide each cluster with a cluster-level VM-container integration controller including cluster command execution control, cluster connection, cluster configuration, cluster resource control, and multi-cluster network connection and monitoring.

The VM-container integration controller may directly communicate with the global integration controller and the VM-container integration controller agent and operate according to the management logic and policy of the global integration controller.

The CSP may provide synchronization mechanisms between the monitoring module of the VM-container integration controller and the corresponding module of the global integration controller, including modules for authentication, registration, connection, resource, and configuration management.

The CSP may provide network management for connection between a VM and a container.

In VM and container integration network management within a single node, a connection may be established by a virtual network bridge, network connections between VMs and containers may be supported, and IP addresses may be allocated and released according to generation and deletion of virtual environments.

The CSP may provide host network connectivity that uses both a VM and a container.

Host network connection management refers to generation of a virtual network bridge and management of the connection between a host network and a network device for connecting VMs and containers.

The CSP may provide support for cross-domain access between nodes in a multi-domain cluster environment that uses VMs and containers in different domains.

For access to VMs or containers in different nodes of different domains, VM and container integration network management may use a virtual network switch between the virtual network bridge and the physical host network.

In order to support cross-node access, the virtual network switch is configured between the bridge and the physical NIC, thereby enabling routing between the domains.

The CSP may provide a collection of network information related to VMs, containers, and a host network.

The network information may include the device names, assigned IP addresses, and traffic status for each virtual and physical network device.

The network information may be used to generate, configure, delete, and monitor virtual network devices within the node.

The VM and container integration management may display detailed network information, such as the scale, direction, and path of data flow on VM networks, system networks, and between external IP addresses.

The CSP may provide real-time network status monitoring to allocate a network between a VM and a container.

The real-time network status may provide information for allocating an optimal network for better operation between a VM and a container.

The CSP may provide a QoS policy based on the real-time network status to optimize network performance.

The VM and container integration management may provide diverse alerts for different network performance issues. By customizing the conditions for triggering these alarms, the efficiency of problem identification and resolution may be effectively improved to better meet business continuity.

The CSP may support deployment of services and workloads across both container-based and VM-based virtualization environments within a unified system architecture (hybrid virtualization deployment).

The CSP may support remote communication between container-based and VM-based workloads deployed across edge clouds, regional clouds, and core clouds (cross-environment communication).

Here, cross-environment communication may include support for consistent data exchange, message brokering, or network bridging across heterogeneous clusters using interoperable protocols and secure tunnels.

A containerized microservice at the edge may communicate with a VM-based AI engine in the core cloud for interference results.

The CSP may provide a unified Application Programming Interface (API) for supporting simultaneous deployment and execution of VMs and containers across geometrically or logically distributed clusters.

The unified API may abstract underlying infrastructure heterogeneity and provide integrated orchestration regardless of a virtualization type or location.

The CSP may support globally accessible storage and centralized integration management for orchestrating container and VM workloads in distributed cloud environments.

The storage may include shared file systems, object storage, and metadata synchronization for cross-cluster applications.

The VM and container-based modules may mount a shared NFS or an in-memory storage layer to exchange status or sensor data.

The CSP may provide high-performance devices directly assigned to VMs or containers through a common interface.

The high-performance devices may include a GPU, an NPU, an FPGA, other hardware accelerators, and the like.

The direct assignment mechanism may include a method of assigning a dedicated hardware accelerator to a single VM or container or assigning a virtualized device.

The CSP may provide high-performance device partitioning and sharing to improve GPU resource utilization.

The CSP may provide automatic scale-up and scale-down of the high-performance devices and support automatic replacement of failed instances.

The CSP may provide data sharing capabilities to enable simultaneous access by a VM and a container in a single node.

The CSP may provide performance metrics to allocate the better option between a VM and a container for an application in a multi-cluster environment.

The performance metrics may include resource change events of a cluster, performance indicators (CPU, memory, and network) of cluster nodes, and latency of a multi-cluster network, and these metrics may be periodically monitored and transmitted to the global integration controller.

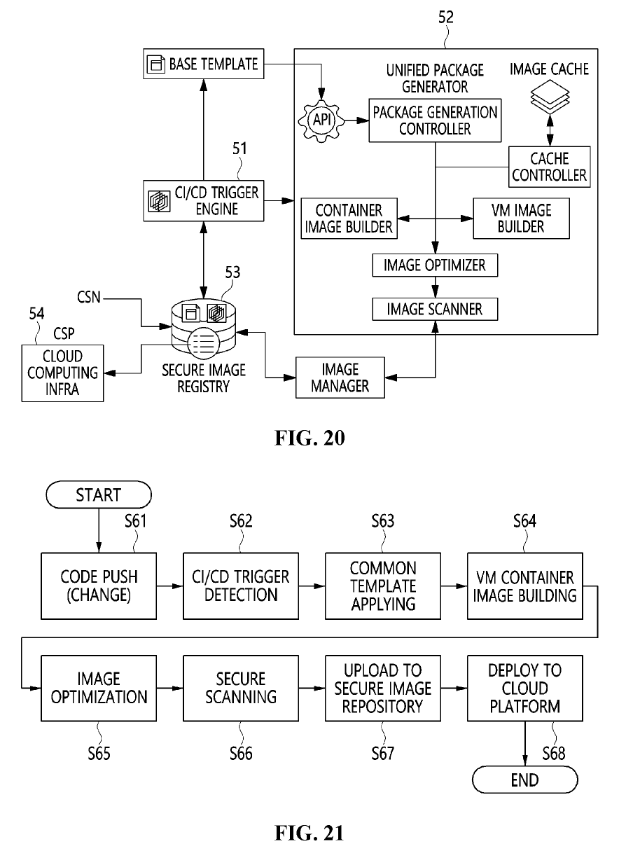

FIG. 21 is a flowchart illustrating a method for integrated image management for virtual machines and containers in a cloud-computing environment according to an embodiment of the present disclosure.

Referring to FIG. 21, it can be seen that continuous integration and continuous deployment are realized by linking a series of processes from code changes to deployment in virtual machine and container environments through an automated pipeline.

First, at step S61, changes in source code may be detected (CODE PUSH (CHANGE)).

Here, at step S61, a developer may push application source code into a Git repository or perform merging.

Also, at step S62, CI/CD trigger detection may be performed.

Here, at step S62, a source code change event is automatically detected through a webhook or the like, thereby activating (triggering) a build process for image generation.

Here, at step S62, a CI/CD trigger engine may detect the change event through a webhook.

For example, at step S62, when a developer pushes code, the CI/CD trigger engine connected to GitLab CI or GitHub Actions may immediately detect the change event and cause a subsequent automated pipeline (an image build process or the like) to be started.

Also, at step S63, common templates may be applied.

That is, at step S63, when the trigger is initiated, a set of predefined standard build templates is referenced, and a request including common configuration specifications and build specifications for generating virtual machine and container images may be delivered to an image generator.

For example, at step S63, common templates, such as Dockerfile for container builds and a Packer template for virtual machine builds may be retrieved and delivered to a unified image generator such that the two heterogeneous environments have the same base configuration and metadata.

Also, at step S64, virtual machine and container images may be built.

That is, at step S64, a virtual machine image and a container image may be built based on the common template.

Here, at step S64, the unified image generator controls both a container image generator and a virtual machine image generator based on the received common template, thereby automatically building heterogeneous images individually or simultaneously.

Here, at step S64, conversion between the built virtual machine image and the built container image may be performed to support the execution of applications across a virtual machine and a container.

For example, at step S64, a virtual machine image may be generated using tools such as virt-builder or Packer, and simultaneously, a container image may be built using Docker or BuildKit according to an execution environment.

Also, at step S65, image optimization may be performed.

That is, at step S65, the image optimization may be performed on the built virtual machine image and container image.

Here is, at step S65,redundant components may be removed from layers common to the built virtual machine image and the built container image and caching may be applied to optimize storage capacity.

Here, at step S65, optimization processing, such as removing unnecessary layers, eliminating redundant components, applying compression, and applying internal caching, may be performed to minimize the storage usage of the generated image and improve the reusability thereof.

For example, at step S65, when building multiple applications using the same base operating system image, layers cached during a previous build may be reused to reduce build time. Here, at step S65, through deduplication, the burden on storage resources may be significantly reduced in environments where high-performance storage or large-capacity storage is required.

Also, at step S66, security scanning may be performed.

That is, at step S66, a security vulnerability scan may be performed on the built virtual machine image and container image.

Here, at step S66, the finally generated images may be automatically analyzed using security scanners such as Trivy, Clair, etc., in order to detect security vulnerabilities or inconsistencies, and whether to deploy the images may be determined according to predefined security policies.

For example, at step S66, when a critical library security vulnerability (policy-violating artifacts) is detected in the image as the result of scanning, deployment may be immediately halted or a flag requiring administrator approval may be set to prevent unsafe code from being introduced into an operating environment.

Also, at step S67, the image may be uploaded to a secure image repository.

That is, at step S67, the virtual machine image or container image on which the security vulnerability scan is performed may be stored in the image repository.

Here, at step S67, the validated virtual machine and container images that have successfully passed security verification may be uploaded to and stored in a centralized secure image registry.

For example, at step S67, for traceability and consistent lifecycle management, a version may be assigned to each uploaded image, and metadata may be stored together with the image, thereby enabling multiple clusters in a multi-cluster environment to concurrently retrieve and pull the images.

Also, at step S68, the image may be deployed to a cloud platform.

That is, at step S68, the virtual machine image or the container image stored in the image repository may be deployed to the cloud system.

The execution platform may include an integrated runtime environment in which both a hypervisor and a container runtime engine are jointly configured within a single node.

Here, at step S68, the deployed virtual machine image and container image may be controlled to be executed concurrently within the single node by sharing scheduling, networking, and storage interfaces.

Here, at step S68, the execution platform to which the image is to be deployed may be dynamically determined based on performance metrics including resource change events of a cluster and node performance indicators, and a predetermined high-performance device provided in the execution platform may be partitioned and a portion thereof may be allocated according to workload requirements of the image to be deployed.

Here, at step S68, the final image stored in the repository may be automatically assigned and deployed to an appropriate execution platform of the cloud-computing infrastructure through the integrated executor (deployment engine).

For example, at step S68, a deployment target may be selected based on a policy without manual intervention by an operator, and a container image is deployed to a runtime environment such as Kubernetes while a virtual machine image is automatically deployed to a hosting environment such as libvirt or KVM, thereby realizing an agile and iterative release environment.

Here, step S68 is performed without manual intervention by an operator, and a target cluster or node for deployment may be selected based on policies.

The present disclosure may be universally applicable in various virtualization and cloud operating environments and may have the following application targets and technological scalability.

Because the present disclosure manages VM and container images based on a common image repository, multiple clusters may simultaneously retrieve and deploy images. Accordingly, consistent image deployment and operation may be enabled even in Kubernetes-based multi-cluster configuration or in a hybrid OpenStack-Kubernetes environment.

The present disclosure provides a lightweight image structure and an automated deployment mechanism, making it suitable for resource-constrained infrastructures such as Mobile Edge Computing (MEC), smart factories, edge AI devices, and the like. Because image transfer and execution are automated, services may be rapidly deployed even on edge nodes.

The present disclosure automatically recognizes Git-based change histories and immediately triggers image build and deployment, thereby fully conforming to an agile software development and operations model (CI/CD) based on DevOps or GitOps. It effectively supports developer-centric iterative release environments.

The present disclosure includes a security scanning function prior to image deployment and a policy-based approval system, and thus may be applied in domains with high security compliance requirements, such as finance, defense, the public sector, and the like. Since images are executed only after the safety thereof has been verified through static analysis, a reliable operating environment may be established.

The present disclosure has a cloud-independent architecture, and thus may be used in conjunction not only with private clouds (OpenStack and VMware) but also with public clouds (AWS, Azure, GCP, etc.). It may also flexibly adapt to hybrid cloud and multi-cloud strategies.

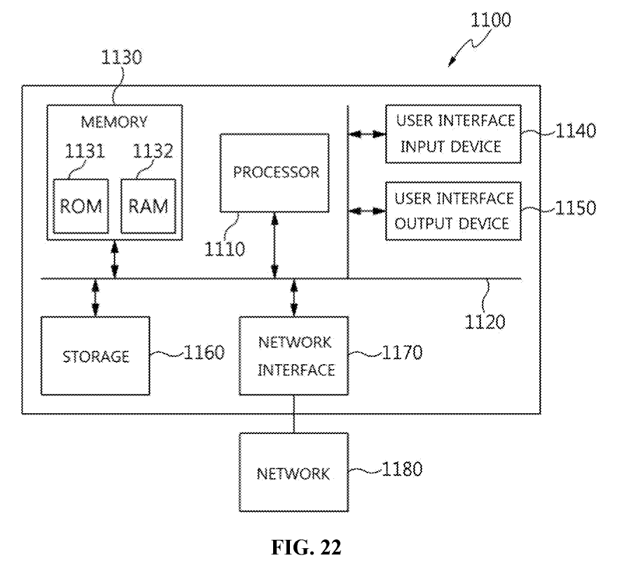

FIG. 22 is a block diagram illustrating a computer system according to an embodiment of the present disclosure.

Referring to FIG. 22, the apparatus for integrated image management for virtual machines and containers in a cloud-computing environment according to an embodiment of the present disclosure may be implemented in a computer system including a computer-readable recording medium. As illustrated in FIG. 22, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for integrated image management for virtual machines and containers in a cloud-computing environment according to an embodiment of the present disclosure includes one or more processors 1110 and memory 1130 for storing at least one program executed by the one or more processors 1110. The at least one program builds a virtual machine image and a container image based on a common template, performs an image optimization on the built virtual machine image and container image performs a security vulnerability scan on the built virtual machine image and container image, stores the virtual machine image or the container image on which the security vulnerability scan is performed in an image repository, and deploys the virtual machine image or the container image stored in the repository to a cloud system.

Here, the image optimization may comprise optimizing storage capacity by removing redundant components from layers common to the built virtual machine image and the built container image and applying caching.

Here, an execution platform may include an integrated runtime environment in which a hypervisor and a container runtime engine are jointly configured within a single node, and the at least one program may control the deployed virtual machine image and container image to be executed concurrently within the single node by sharing scheduling, networking, and storage interfaces.

Here, the at least one program may perform conversion between the built virtual machine image and the built container image, thereby supporting the execution of applications across a virtual machine and a container.

Here, the at least one program may dynamically determine the execution platform to which the image is to be deployed based on performance metrics including resource change events of a cluster and node performance indicators, and may partition a predetermined high-performance device provided in the execution platform and allocate a portion thereof according to workload requirements of the image to be deployed.

The present disclosure may provide an integrated CI/CD-based image generation and deployment structure in virtual machine and container environments.

Also, the present disclosure may enable continuous integration and continuous deployment without manual intervention by automatically generating and deploying virtual machine images and container images.

Also, the present disclosure may automatically perform image building, testing, and deployment in conjunction with a CI/CD pipeline when code changes.

Also, the present disclosure may ensure build efficiency through caching and version management of images.

Also, the present disclosure may ensure stability and reliability through security verification and conditional deployment of images.

Also, the present disclosure may maintain a consistent deployment process even in heterogeneous virtualization environments (KVM, Kubernetes, etc.).

Also, the present disclosure may automatically analyze security vulnerabilities and determine deployment according to preset policies, thereby preventing unsafe code from being introduced into an operating environment.

Also, the present disclosure may minimize the likelihood of failures caused by version differences or configuration inconsistencies between generated images.

Also, the present disclosure may efficiently utilize storage space by removing unnecessary layers in an image generation process and managing common images based on a cache.

Also, the present disclosure may reduce the burden associated with high-performance storage or large-capacity storage.

Also, the present disclosure may be applied to various real-world environments, such as distributed cloud, 5G MEC, and edge AI.

As described above, the apparatus, method, and storage medium for integrated image management for virtual machines and containers in a cloud-computing environment according to the present disclosure are not limitedly applied to the configurations and operations of the above-described embodiments, but all or some of the embodiments may be selectively combined and configured, so the embodiments may be modified in various ways.

What is claimed is:

1. An apparatus for integrated image management for virtual machines and containers in a cloud-computing environment, comprising:
one or more processors; and
memory for storing at least one program executed by the one or more processors,
wherein the at least one program
builds a virtual machine image and a container image based on a common template,
performs an image optimization on the built virtual machine image and container image,
performs a security vulnerability scan on the built virtual machine image and container image,
stores the virtual machine image or the container image on which the security vulnerability scan is performed in an image repository, and
deploys the virtual machine image or the container image stored in the image repository to a cloud system.

2. The apparatus of claim 1, wherein the image optimization comprises optimizing storage capacity by removing redundant components from layers common to the built virtual machine image and the built container image and applying caching.

3. The apparatus of claim 1, wherein
an execution platform includes an integrated runtime environment in which a hypervisor and a container runtime engine are jointly configured within a single node, and
the at least one program controls the deployed virtual machine image and container image to be executed concurrently within the single node by sharing scheduling, networking, and storage interfaces.

4. The apparatus of claim 1, wherein the at least one program performs conversion between the built virtual machine image and the built container image to support execution of applications across a virtual machine and a container.

5. The apparatus of claim 1, wherein the at least one program dynamically determines an execution platform to which the image is to be deployed based on performance metrics including resource change events of a cluster and node performance indicators, and partitions a predetermined high-performance device included in the execution platform and allocates a portion thereof according to workload requirements of the image to be deployed.

6. A method for integrated image management for virtual machines and containers in a cloud-computing environment, performed by an apparatus for integrated image management for virtual machines and containers in a cloud-computing environment, comprising:
building a virtual machine image and a container image based on a common template;
performing an image optimization on the built virtual machine image and container image;
performing a security vulnerability scan on the built virtual machine image and container image;
storing the virtual machine image or the container image on which the security vulnerability scan is performed in an image repository; and
deploying the virtual machine image or the container image stored in the image repository to a cloud system.

7. The method of claim 6, wherein the image optimization comprises optimizing storage capacity by removing redundant components from layers common to the built virtual machine image and the built container image and applying caching.

8. The method of claim 6, wherein
an execution platform includes an integrated runtime environment in which a hypervisor and a container runtime engine are jointly configured within a single node, and
deploying the virtual machine image or the container image comprises controlling the deployed virtual machine image and container image to be executed concurrently within the single node by sharing scheduling, networking, and storage interfaces.

9. The method of claim 6, wherein building the virtual machine image and the container image comprises performing conversion between the built virtual machine image and the built container image to support execution of applications across a virtual machine and a container.

10. The method of claim 6, wherein deploying the virtual machine image or the container image comprises dynamically determining an execution platform to which the image is to be deployed based on performance metrics including resource change events of a cluster and node performance indicators; and partitioning a predetermined high-performance device included in the execution platform and allocating a portion thereof according to workload requirements of the image to be deployed.

11. A storage medium storing a program for performing a method for integrated image management for virtual machines and containers in a cloud-computing environment,
the method comprising:
building a virtual machine image and a container image based on a common template,
performing an image optimization on the built virtual machine image and container image,
performing a security vulnerability scan on the built virtual machine image and container image,
storing the virtual machine image or the container image on which the security vulnerability scan is performed in an image repository, and
deploying the virtual machine image or the container image stored in the image repository to a cloud system.

12. The storage medium of claim 11, wherein the image optimization comprises optimizing storage capacity by removing redundant components from layers common to the built virtual machine image and the built container image and applying caching.

13. The storage medium of claim 11, wherein
an execution platform includes an integrated runtime environment in which a hypervisor and a container runtime engine are jointly configured within a single node, and
deploying the virtual machine image or the container image comprises controlling the deployed virtual machine image and container image to be executed concurrently within the single node by sharing scheduling, networking, and storage interfaces.

14. The storage medium of claim 11, wherein building the virtual machine image and the container image comprises performing conversion between the built virtual machine image and the built container image to support execution of applications across a virtual machine and a container.

15. The storage medium of claim 11, wherein deploying the virtual machine image or the container image comprises dynamically determining an execution platform to which the image is to be deployed based on performance metrics including resource change events of a cluster and node performance indicators; and partitioning a predetermined high-performance device included in the execution platform and allocating a portion thereof according to workload requirements of the image to be deployed.
